(19) United States
(12) Patent Application Publication
(10) Pub. No.: US 2020/0314489 A1
(43) Pub. Date: Oct. 1, 2020

(54) SYSTEM AND METHOD FOR VISUAL-BASED TRAINING

(71) Applicant: Visyn Inc., Lino Lakes, MN (US)

(72) Inventors: Jeffrey Thielen, Lino Lakes, MN (US); Andrew John Blaylock, Minneapolis, MN (US)

(21) Appl. No.: 16/845,812

(22) Filed: Apr. 10, 2020

Related U.S. Application Data
(63) Continuation of application No. 15/542,315, filed on Jul. 7, 2017, now abandoned.
(60) Provisional application No. 62/100,799, filed on Jan. 7, 2015.

(51) Int. Cl. H04N 21/442; G09B 5/06; G09B 19/00

(52) U.S. Cl. CPC H04N 21/44218; H04N 21/44204; G09B 19/0038; G09B 19/003; G09B 5/065

(57) ABSTRACT

This document describes a computer-based visual-based training system that includes five main components: video repetition, user motion capture, virtual reality training, automated feedback, and automated skill progression.

### CLAIM OF PRIORITY

The present application is a continuation of U.S. patent application Ser. No. 15/542,315, filed Jul. 7, 2017, which is a U.S. National Stage Filing Under 35 U.S.C. § 371 of International Patent Application Serial No. PCT/US2016/012495, filed Jan. 7, 2016, and published on Jul. 14, 2016 as WO/2016/112194, which claims the benefit of priority of U.S. Provisional Application Ser. No. 62/100,799, filed Jan. 7, 2015, the benefit of priority of each of which is claimed hereby and each of which are incorporated by reference herein in its entirety.

### BACKGROUND

People practice skills to improve performance in sports and other endeavors. Practice typically involves repeatedly performing skills. Practice may occur in a group setting, in one-on-one sessions, or independently. Focus is an important part of learning a skill and distractions may regularly occur in a group setting. Focused learning is typically easier in a one-on-one session with a coach, but such training is often cost prohibitive. Some people attempt to practice alone using training videos. However, not all skills may be practiced individually. Also, without coaching, the person may not practice the correct form and fail to improve. Videos may also be limited in content and result in inattention—ultimately negating any usefulness of the videos.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic drawing illustrating a system for presenting video to a user, according to an embodiment;

FIG. 2 is a flowchart illustrating a method of delivering video to a viewer, according to an embodiment;

FIG. 3 is a block diagram illustrating a system for visual-based training, according to an embodiment;

FIG. 4 is a flowchart illustrating a method of visual-based training, according to an embodiment;

FIG. 5 is a block diagram illustrating a system for subskill classification, according to an embodiment;

FIG. 6 is a flowchart illustrating a method of subskill classification, according to an embodiment;

FIG. 7 is a block diagram illustrating a system for defining a skill progression, according to an embodiment;

FIG. 8 is a flowchart illustrating a method of defining a skill progression, according to an embodiment;

FIG. 9 is an example of a skill drill matrix, according to an embodiment;

FIG. 10 is an example of the skill drill matrix, according to an embodiment;

FIG. 11 is an example of the skill drill matrix, according to an embodiment;

FIG. 12 illustrates certain components according to an embodiment;

FIG. 13 is a block diagram illustrating a system for error detection and prioritization, according to an embodiment;

FIG. 14 is a flowchart illustrating a method of error detection and prioritization, according to an embodiment;

FIG. 15 is a block diagram illustrating control flow of a training system, according to an embodiment;

FIG. 16 is a block diagram illustrating a system for skill training, according to an embodiment;

FIG. 17 is a flowchart illustrating a method of skill training, according to an embodiment;

FIG. 18 is a block diagram illustrating a system for visual-based training, according to an embodiment;

FIG. 19 is a flowchart illustrating a method of visual-based training, according to an embodiment;

FIG. 20 is a block diagram illustrating a system for visual-based training, according to an embodiment;

FIG. 21 is a flowchart illustrating a method of visual-based training, according to an embodiment; and

FIG. 22 is a block diagram illustrating a system for visual-based training, according to an embodiment;

FIG. 23 is a flowchart illustrating a method of visual-based training, according to an embodiment; and

FIG. 24 is a block diagram illustrating a machine in the example form of a computer system, within which a set or sequence of instructions may be executed to cause the machine to perform any one of the methodologies discussed herein, according to an example embodiment.

### DETAILED DESCRIPTION

### Introduction

Today's athletes are always looking for competitive advantages. In order to perfect their skills, athletes must practice frequently, but often they lack organization and feedback when practicing. Other times, athletes are too busy or too tired to physically practice. In order to attempt to make better use of athletes' time, visual-based training may be incorporated into a training schedule and may supplement or replace some component of a practice routine. Visual-based training may include video-based training on a traditional screen, as well as in virtual reality or augmented reality, observation of a live person training, visualization training, vision training, or the like. Visual-based training systems may be configured to show a user proper mechanics and teach read and react skills using a variety of methods, such as by showing a professional performing a skill, showing a computer-generated figure modeling a skill, showing the athlete performing a skill, or the like. These training systems may also use other visuals and graphics overlaid on underlying video. Visual-based training may be performed with or without physical movement by the user.

Certain neurological factors may aid or impede a user in learning a skill. Neurological factors include inattention, which may be due to fatigue, distraction, habituation, boredom, or the like. Each of these factors is relevant to how a user learns a skill. For example, fatigue may cause a user to perform a skill improperly, negating the usefulness of practicing the skill. Fatigue may also cause a user viewing a visual-based training system to lose focus and not see or not retain components of the video.

Memory affects mirror neurons, which are neurons that fire both when a user performs a skill or watches a skill performed by another person. Hence, these particular neurons “mirror” the behavior of the other person, as though the observer were acting himself. Scientists have discovered brain activity consistent with mirror neurons in the premotor cortex, supplementary motor area, primary somatosensory cortex, and inferior parietal cortex of humans. More specifically, magnetic resonance imaging (MRI) tests have shown that the human inferior frontal cortex and superior parietal lobe are active when the person performs an action, as well as when the person observes another person performing that same action.

The systems and methods described herein leverage visual-based training to engage the mirror neurons and other neurons in the brain and neural pathways for skill development. Although some examples illustrated herein refer to athletes and athletic skill development, it is understood that any type of motor skill may be developed using these mechanisms. Motor skills used to play instruments, operate vehicles, dance, or other physical endeavors may be practiced using visual-based training.

### Terminology

For the purposes of this document, the term “skill” refers to a person's ability to choose and perform the correct subskills at the correct time, successfully, regularly, and with minimum effort. A skill is learned and is composed of using ones abilities to perform one or more subskills.

A “subskill” is a basic movement of a sport or activity. A combination of a number of subskills into a pattern of movement results in a skill. Subskills may further be reduced into sub-subskills and so on.

An “ability” refers to a person's perceptual or motor functions. Most abilities are a combination of perceptual and motor functions and are referred to as psychomotor abilities. Various psychomotor abilities include muscular power and endurance, flexibility, balance, coordination, and differential relaxation (selective adjustment of muscle tension). Psychomotor abilities may be viewed as gross motor abilities, such as extent flexibility, dynamic flexibility, explosive strength, static strength, dynamic strength, trunk strength, gross body coordination, gross body equilibrium, and stamina.

As an example, a 100-meter race may be considered a skill, which includes various abilities (e.g., balance, muscular power) and several subskills (e.g., block start, initial run, mid-race run, and finishing form).

As another example, a block start subskill may be considered a skill, which includes abilities and additional subskills (e.g., rear and front foot placement, initial push off, reaction to starting gun, etc.). Thus, it is understood that the use of “skill” in this document may be replaced with the term “subskill” and a corresponding change in the resolution or scope of the activity being discussed.

An “exercise” is a physical or perceptual task to train a person to use an ability or abilities. Exercises may be general exercises (e.g., pushups) or skill-specific (or subskill-specific) exercises (e.g., swing practice with a weighted golf club).

### SUMMARY

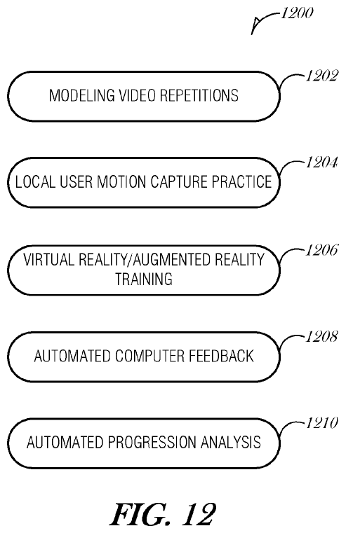

This document describes a computer-based visual-based training system that includes five main components: video repetition, local user motion capture, virtual reality/augmented reality training, automated feedback, and automated skill progression. FIG. 12 illustrates these components.

Video repetition (block 1202) is used to ingrain a skill into a user's memory and trigger mirror neurons or other neurons to assist in skill training. To increase a user's retention, visual presentations may be automatically or manually modified to increase the user's attention. Modifying the visual presentation may reduce or eliminate inattention. Visual repetition (block 1202) may also be used to train a read-and-react skill.

Physical activities to emulate and practice the skill demonstrated in the visual presentation may also be performed by the user (block 1204). The physical activities may be captured by an image capture device (e.g., a video camera) and used to determine how accurate the user's performance was compared to a model performance. The user may perform some skills in a virtual reality or an augmented reality environment (block 1206) and receive feedback in the environment.

Feedback may be provided in several forms (block 1208), including displaying an overlay of the user's actions on top of a representation of the model actions. As the user progresses through skill development, the system may provide additional lateral or longitudinal pathways for skill progression (block 1210).

### Video Repetitions

In one example, a visual-based training system includes showing a user a model version of a skill using a professional or professionals (e.g., someone proficient at the skill). While the professional(s) performs the skill, image capture is used to store the model version of the skill. Image capture may include multiple video cameras capturing video from multiple angles, a single stationary camera, a single camera in motion during the image capture, or the like. The image captured may be manipulated to include additional information that may be useful to the user.

While practicing the skill, video of a user performing a skill may be captured. The video of the user may be shown to the user with or without manipulation to aid in learning the skill. The video of the user may be overlaid with a video or a computer generated graphic of the model version of the skill, to show the user differences between the user's position or movements and model position or movements for the skill.

A visual-based training system may include teaching a user a skill using video-assisted mechanisms. A model version of the skill may be shown to the user in a series of repeated videos. The repeated videos may be the same video repeating, slightly varying videos, drastically varying videos, or a combination of these. The repeated videos may be accompanied by additional stimuli introduced to prevent the user from experiencing inattention.

The visual-based training system may also include teaching a user a read-and-react skill using video-assisted mechanisms. Read-and-react skills are actions performed by the user in reaction to an event. The videos may provide a scenario, such as a game situation where the user is provided a certain cue or stimulus, and expected to react in a certain way. For example, a user may first be provided a rule, such as the positional movements of a second baseman in certain situations after a ball is hit. Then the user may be presented the scenario in video form and be expected to react in the correct manner. As the user gains proficiency, the number of scenarios or variables in a scenario may vary to train the user to recognize and react correctly.

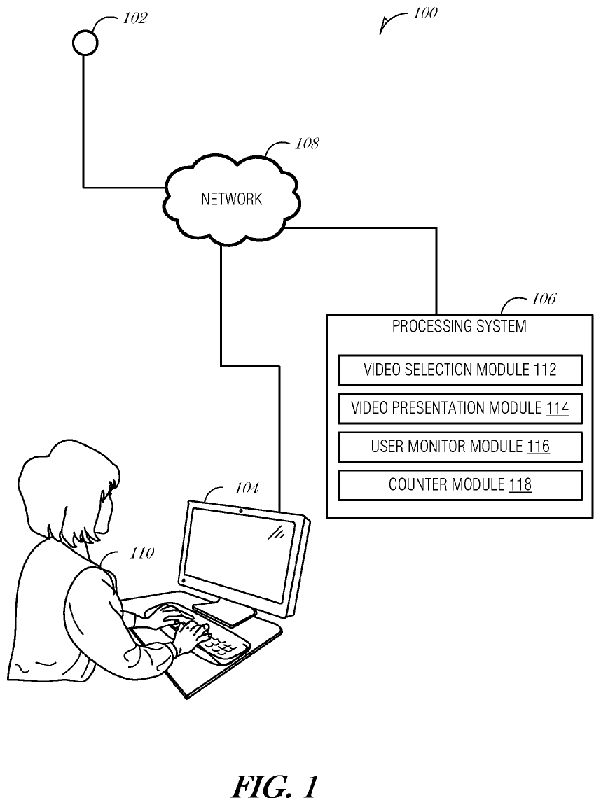

FIG. 1 is a schematic drawing illustrating a system 100 for presenting video to a user, according to an embodiment. The system 100 includes a camera 102 and a media playback device 104. While only one camera 102 is illustrated in FIG. 1, it is understood that two or more cameras may be used. The camera 102 may be integrated into the media playback device 104. The camera 102 may be a standalone device (e.g., a ceiling-mounted camera) or an integrated device (e.g., a camera in a smartphone). The camera 102 may be incorporated into a wearable device, such as a watch, glasses, or the like, for use in virtual reality systems or augmented reality systems.

The media playback device 104 may be any type of device with an audio and visual output. The media playback device 104 may be a smartphone, laptop, tablet, headset, glasses, or the like.

A processing system 106 is connected to the media playback device 104 and the camera 102 via a network 108. The processing system 106 may be incorporated into the media playback device 104, located local to the media playback device 104 as a separate device, or hosted in the cloud accessible via the network 108.

The network 108 includes any type of wired or wireless communication network or combinations of wired or wireless networks. Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The network 108 may backhaul the data to the core network (e.g., to the datacenter or other destinations).

During operation, the processing system 106 monitors usage of the system 100. A user 110 may access the processing system 106, such as by logging in to a website hosting the processing system 106, or by using a client application executing on the playback device 104 to access the processing system 106. The user 110 may view video clips, video streams, workout logs, skill progression trees, or other information related to the user's skill training.

The processing system 106 may then adjust video or audio content for the user 110 based on the user's viewing history, preferences, sensor feedback, or other information. In general, the processing system 106 is configured to detect a user's attention level to detect a lapse in attention. Based on this observation, the processing system 106 may adjust which video segments are used, how they are presented, or other aspects of the content or presentation.

In order to change the video for subsequent viewings, the processing system 106 tracks the user. One way that the processing system 106 may track the user is to track the usage. The usage may be tracked across five metrics. The first metric is what content is viewed and when. This information may be used to avoid replaying the same or similar content that was deemed to be less interesting to the user. This metric may also be used to track an “attention loss” factor for each item viewed. This metric may be used as a weight in a weighted function and may determine how quickly changes are made to new content. For example, the attention loss factor may be used to track when some content becomes boring more quickly than other content, in which case the attention loss factor is considered higher. When a viewing is terminated early (e.g., aborted), the duration viewed (or unviewed), the point in the video where the viewing was terminated, or other aspects of an aborted viewing may be used to determine attention loss. Similarly, aspects related to when a person pauses viewing (e.g., duration viewed, portion of video when pause occurred, average pause duration, etc.) may be used.

The second metric that the processing system 106 may track is the number of viewings. The third metric the processing system 106 may track is the recent frequency of the viewings. The frequency may be tracked over a periods of time, such as when during a particular day, week, or month. The fourth metric the processing system 106 may track is the duration of recent viewings. The fifth metric to track is a mathematically calculated composite of the values of the other four or a subset of those four.

Each factor may have a running tally. Over time, as the user views videos, each video watched affects the values for viewings, frequency, and duration and those in turn will affect the composite. After a change to a video or a sequence of videos, the metrics may be reset to a starting point and begin accumulating again toward the point where some more variety may be introduced into the videos.

Each of the five metrics tracked include a threshold, which if crossed triggers the introduction of an element (or elements) of change into subsequent video presentations. For the number of views metric, the threshold may be a certain number of viewings. For the frequency of viewing value, the number of completed viewings in a period (e.g., the most recent week) may be tracked. For the duration of viewing metric, the metric may account for any viewers who happen to have recently been watching videos that are longer than our average or to account for non-completed viewings where the viewing does not contribute to the “number of viewings” metric.

For the composite metric of the other tracked items, one mechanism is to use a weighted sum of a subset of the other four values where weights are assigned to denote “importance” to the various values. Also, for the frequency and duration metrics, a minimum value may be used to filter these metric values before they are accounted in the composite equation. In other words, if the frequency and duration metrics fail to meet the minimums, then a non-value (e.g., zero) may be entered into the composite equation, thus not contributing to the composite metric.

In an embodiment, a composite metric that factors the total number of completed views and the frequency of views values is used. The other two values may not be a consideration in the composite metric. For example, the duration is likely a redundant consideration that only complicates things in most cases.

Additional mechanisms may be used to determine whether a person is inattentive. Included herein is a non-exclusive list of mechanisms to detect patterns of actions that may indicate inattentiveness. An increase in aborted viewings frequency may indicate inattention due to boredom. A decrease in viewing frequency may indicate inattention due to fatigue. An increase in aborted viewings frequency and a decrease in viewing frequency together may indicate inattention. A recent run of high frequency viewing may preclude a period of inattention to follow due to overexposure. An increase in aborted viewings frequency and a decrease in aborted viewings view duration may indicate inattention. A high rate of pausing the video coupled with an increase in aborted viewings may indicate that the user is simply getting interrupted a lot and not necessarily losing attention. In such a case, the system may suggest that the user find a more private area in which to view videos. A change in viewing time of day could indicate a change in user mindset.

When detecting a low-to-medium strength indications on any of the patterns, user feedback may also be obtained. For example, the user may be presented with a dialogue box stating, “We have noticed that you have stopped your videos before they were completed 3 times in the last 7 video sessions. What reason have you been doing this?” Options may be provided and the user may select either “I have been experiencing interruptions” or “I would like to see a different video.” If their answer is “interruptions,” the system suggests moving to a more private area to view videos. If their answer is “different video,” the system introduces variety.

In addition to viewing metrics, biometric considerations may also be tracked. This may be done using a computer's front facing camera to identify patterns of body heat using infrared light, heartbeat, eye motion, and time spent looking at the screen, or a physical test of nervous system readiness, such as rate of tapping the space bar when asked to tap as rapidly as possible.

Example embodiments include an embodiment where a single threshold for aborted viewing frequency over the past nine viewings is used. That threshold may be four aborted viewings. If that threshold is exceeded, the system would introduce variety.

In a related embodiment, the system may maintain two thresholds over the same viewing sample. For example, for aborted viewing frequency, the sample may still be the past nine viewings. In this case the system may still introduce variety if there were four aborted viewings in that sample. However, if there were only three aborted viewings in the past nine viewings, the system may offer a prompt and ask for user feedback to determine the best course of action. If the feedback was not indicative of the need to introduce variety, the system may do nothing, yet vigilantly await the stronger four out of nine signal.

In a related embodiment, the system may operate on the aborted viewings frequency data with multiple sample spaces. There may be a sample space representing the past seven viewings and another sample space that represents the past nineteen viewings. The system may look for a three-out-of-the-past-seven-viewings signal as well as a seven-out-of-the-past-nineteen-viewings signal. If either is exceeded, it would introduce variety.

In a related embodiment, the system may consider all of the viewings in a recent time frame. So, instead of considering the most recent number of viewings, the system may consider all of the viewings in the most recent two weeks. Then the threshold would be a percentage as opposed to a number. So, if the user aborted 35% or more viewings in the most recent two weeks the system would introduce variety.

In a related embodiment, the system may consider both the most recent two weeks and the most recent six weeks with a lower percentage threshold for the longer period than for the shorter period. The system may look for a 25% or more aborted viewings percentage over the most recent six weeks and a 35% or more aborted viewings percentage over the most recent two weeks and would introduce variety in either case.

In a related embodiment, the system may consider a distinct change in a tracked value. The system may track aborted viewings from week to week. For this calculation, define the week that occurred between 14 and 8 days ago as Week 1. Define the week that occurred between 7 and 1 days ago as Week 2. Dividing the percentage of aborted viewings in Week 2 by the percentage of aborted viewings in Week 1 results in a ratio that indicates a rate of change in user behavior. If that ratio value is higher than two the system would introduce variety.

For the purposes of the following embodiments, consider the concept of signal strength. For the previously discussed embodiments there may be multiple thresholds. For example, one threshold may be used to indicate a “strong” signal. If the system detects a strong signal it would introduce variety. A lower threshold may indicate a medium signal. With a medium signal, nothing may be done with that signal alone, but coupled with other medium signals in other tracked user behavior metrics, the system would identify a pattern that would trigger the introduction of variety.

In an embodiment, the value of aborted viewing frequency, viewing frequency overall, and average view duration may all be in a medium signal strength condition. This combination of medium strength signals would be fit into a pre-defined “pattern” that is indicative of inattention and the introduction of variety would be triggered. Note that for aborted viewing frequency, the medium strength threshold may need to be lower than the aborted viewing frequency value. For the other two metrics, the opposite is true. To be in a medium strength condition, the value would actually have to be lower than the medium strength threshold (because for viewing frequency, and average view duration, high values would be indicative of retained attention).

Another way to factor in multiple signals is to create a weighted function that applies a different coefficient multiplier to each of a set of tracked metric values and sums these together to output a scalar value. This scalar value may then need to exceed a threshold value to trigger the introduction of variety. For the cases of metrics that are indicative of attention when they are high, the may need to perform a division operation and a subtraction operation before multiplying by the coefficient. For example, the function may take the form:

c1*Aborted Viewing Frequency+c2*(1−(viewing frequency/prescribed viewing frequency))+c3*(1−(average view duration/average video length))=scalar value (Eq. 1)

where c1, c2, and c3 are coefficients which weight the importance of each metric and scale the result to be appropriate relative to the selected threshold value.

Note that each of the embodiments listed above may be a test and that several tests may run in parallel. The system may run different types of tests (for example week 1 to week 2 change, threshold over the past nine viewings, and frequency threshold over the past two weeks) all in parallel for the same metric (frequency of aborted viewings). The system may also be running these tests over multiple metrics (aborted viewing frequency, viewing frequency, pause rate) in parallel. The system may run compound tests (looking for patterns indicated by mediums strength signals in multiple metrics or creating a weighted function to produce a scalar value which takes multiple metrics into account) while running single metric tests in parallel. In such a situation, when any of these reaches a trigger state for variety the system would introduce variety.

With each of these embodiments the next question becomes about what to do when the introduction of variety is triggered. The first is to put the system into a condition that delays the next introduction of variety. The system may perform this by resetting the metrics so they do not immediately trigger the introduction of variety again. This may also be done by preventing the system from considering the data that caused the variety trigger most recently. Finally, it may also be done by creating a minimum time frame between variety introductions. Also, the number of viewings metric can be set to a default value following the introduction of variety.

Finally, the nature of the trigger and/or the state of all of the tracked metrics used in the system may inform how the replacement video segment is selected when introducing variety. In addition to user preferences, cultural considerations, seasonal considerations, and more, viewing history may have an impact on what replacement video is selected (in addition to simply being used to eliminate recently viewed styles and types of music or visual composition from consideration).

It is worth noting that there is a good reason for not introducing variety for every viewing. While there is large value in bringing user attention back onto the training content by introducing variety, there is also value in using a certain amount of consistency because using variety in music and visual styles all of the time could be a distraction that would negatively impact training. This system allows the best of both worlds.

When variety is introduced into a media presentation, the variety introduced may be executed within the video shown in the next viewing or it may be an intervention in the current viewing. If the variety is an intervention in the current viewing, it may be performed interrupting the ongoing viewing, such as by using a “jarring” cut in including visuals or audio unrelated to the physical skill subject matter to “reset” the user's attention. After this, the same physical skill subject matter may resume with very different visual or audio styles.

In other implementations, the variety may be introduced in a pre-planned or pre-specified order of visual or audio styles that are used or cycled through, moving from one to the next whenever variety is needed. The variety may also come from a pool of such styles where one or more are selected based on a dynamic calculation that prioritizes some styles over the others by factoring in visual styles used most recently, customer preferences, the specific reason that caused the trigger of change, time of the day, time of the year, cultural consideration, or other considerations. Variety may also be sequential, but not be strictly related to visual and audio style changes. Instead it may be introduced as changes of subject matter driven by the logical progression in the skill development of a given discipline, such as from simple and foundational skills to more complex and advanced skills. Within progression itself, changes in visual or audio style may be used and may be either pre-planned or determined by a mathematical calculation both as previously described. Visual styles may include slow motion video, fast motion video, wireframe video, stick figure video, 3D animation video, live model video, or the like. Audio styles may include various music genres or background tracks, audio volume, equalization, or the like.

Video content may be generally characterized into categories, such as (1) movement skill content, (2) visual style of the background, (3) visual style of the “skin” placed on the human movement model, (4) musical style, and (5) neuroscience optimization strategy.

With the four characteristic categories listed (2) through (5) above, the system is able to mix different “types” together to provide customized videos to the user. For each category, the system may store three types and produce videos that mix all of the different types together. Metadata attached to each video may be used to specify which type in each category that is included in the video. In this way, when the system needs to provide a “novel” video, it will have pre-prepared videos or will render them on the fly so it can select a new one based on the criteria established for doing so and ensure that it doesn't have the same “types” for these categories.

In addition to those four characteristic categories, the first category is also important. The movement skill content category differentiates what sort of human movement is displayed in the video. This means that each of our videos may specifically target a certain portion of a technique progression. That further means that it may contain video demonstrations of a skill or subskill or multiple skills or subskills. These video types may be displayed in sequence that roughly matches the simple-to-complex skill progression of a sport or other movement skill discipline.

The other categories are then present as a way to offer variety without changing movement skill content. Within the progression from simple to complex skills, each portion of that technique progression would feature several video options which are different in that they have different types within the other categories (categories 2 through 5). In other words, each of these video options (pre-prepared or rendered on the fly) within a given portion of the technique progression would contain identical information pertaining to the human movement skill they are displaying, but they would feature different visual styles, music, or other to create a differentiated viewing experience while teaching the same movement.

So, each of these categories may be thought of as a dimension on which the system is able to vary the nature of the video content. This allows the system to create a multi-dimensional progression array. One dimension of the array may be movement skill content. This would follow a pre-specified order (movement skill content type 1 generally before movement skill content type 2, and so on). Also, in order to provide sufficient repetitions, movement skill type 1 may be played multiple times before moving on to movement skill type 2 which would then also be played multiple times. Again, within the sequence of viewings of any single movement skill type, the visual style and music may be varied to maintain attention while still showing the same movement skill content.

In some cases, it is possible that the system introduces skills out of order, e.g., movement skill type 2 before the user is totally finished training on skill type 1. So in this case, after showing movement skill type 1 content several times, the system provides movement skill type 2 content once before showing type 1 several more times to complete training on type 1 content. This concept generalizes to any portion of the technique progression. Other mixing that introduces next techniques before completing training on current ones is obviously possible. However it may be done within the general idea of moving in a pre-specified order from simple techniques to more complex ones.

In some aspects of the system, the system retains user attention by showing them new content when there are indications that they have been overexposed to previously viewed types. This is referred to as “introducing variety.” One way to introduce variety is simply to move to that next movement skill content type in the technique progression. But, the system may not want to move the user forward in that dimension until sufficient repetitions have been achieved. So the ability to change the video in other ways to make it more interesting is needed. This is solved with flexibility built into the multi-dimensional content progression.

Variety may be introduced manually with a user or coach interface system built into the user interface. The user interface may include a control interface on a website or app, and may include instructions to the user or coach on how to use the interface to most effectively introduce variety in the training.

Thus, returning to FIG. 1, the processing system 106 may include a system for delivering video to a viewer, the system comprising: a video selection module 112 to select a video segment from a plurality of video segments, where the plurality of video segments includes content of demonstrations of a skill. In an embodiment, to obtain the replacement video segment, the video selection module 112 is to modify the video segment. The videos may be modified on the server, at the person's computer, or elsewhere. Various possible video modifications are discussed in other parts of this document, but may include altering music tracks, increasing or decreasing playback volume, adding special effects to elements on the periphery to stimulate the user's peripheral vision, changing the perspective or view of the actor performing skills in the video, using wireframe, slow motion, etc.

In an embodiment, to obtain the replacement video segment, the video selection module 112 is to select the new video segment from the plurality of video segments. In a further embodiment, to select the new video segment, the video selection module 112 is to: access a history of viewings of the video segment; and select the new video segment based on the history. In a further embodiment, the history of viewings comprises an identification of the video segment, a number of viewings of the video segment, and a frequency of the number of viewings in a recent timeframe; and to select the new video segment based on the history, the video selection module 112 is to: determine whether the number of viewings exceeds a viewing threshold; determine whether the frequency of the number of viewings in the recent timeframe exceeds a frequency threshold; and select the new video segment when the viewing threshold or the frequency threshold is violated. The video may be any length, such as 10 second or 30 minutes. In various embodiments, the recent timeframe comprises a month, the frequency threshold comprises one-thousand times in the month, the recent timeframe comprises a week, or the frequency threshold comprises one-hundred times in the week. In other embodiments with longer video segments, the threshold may be 3 times in a week. In an embodiment, the history of viewings further comprises a duration of the number of viewings in the recent timeframe; and to select the new video segment based on the history, the video selection module 112 is to: aggregate the number of viewings, the frequency of the number of viewings in the recent timeframe, and the duration of the number of viewings in the recent timeframe to produce an aggregate value; and select the new video segment when the aggregate value exceeds a threshold. In an embodiment, to aggregate to produce the aggregate value, the video selection module 112 is to use a weighted function of the number of viewings, the frequency of the number of viewings in the recent timeframe, and the duration of the number of viewings in the recent timeframe. In a further embodiment, the weighted function implements a minimum number of frequency of the number of viewings in the recent timeframe before including the frequency of the number of viewings in the recent timeframe in the weighted function.

In an embodiment, there may be multiple thresholds, such as one threshold for a week-long period and a second threshold for a month-long period. If either threshold is violated, then a new video segment may be selected and presented.

In another embodiment, the weighted function implements a minimum number of duration of the number of viewings in the recent timeframe before including the duration of the number of viewings in the recent timeframe in the weighted function.

In a further embodiment, the processing system 106 includes a counter module 118 to reset the number of viewings to zero after selecting the new video segment. In an embodiment, the counter module 118 may be configured to reset the frequency of the number of viewings to zero after selecting the new video segment. In an embodiment, the counter module 118 may be configured to reset the duration of the number of viewings to zero after selecting the new video segment.

In an embodiment, to select the new video segment from the plurality of video segments, the video selection module 112 is to: select a video segment from the plurality of video segments based on at least one of: a video style, a user preference, a time, a cultural consideration, or a cause of inattention.

In an embodiment, to select the new video segment from the plurality of video segments, the video selection module 112 is to: select a video segment from the plurality of video segments based on a mathematical calculation.

In an embodiment, to select the new video segment from the plurality of video segments, the video selection module 112 is to: select a video segment from the plurality of video segments based on a skill progression template.

The processing system 106 may also include a video presentation module 114 to present the video segment multiple times to a user during a visual-based training session to train the user in the skill.

The processing system 106 may also include a user monitor module 116 to determine that the user has become inattentive. In an embodiment, the video selection module 112 is to obtain a replacement video segment in response to determining that the user has become inattentive, and the video presentation module 114 is to present the replacement video segment to the user.

In an embodiment, to determine that the user has become inattentive, the user monitor module is to access a history of viewings of the video segment and determine that the user has become inattentive based on the number of viewings of the video segment. In a further embodiment, the history of viewings comprises an identification of the video segment, a number of viewings of the video segment, and a frequency of the number of viewings in a recent timeframe. In a further embodiment, to determine that the user has become inattentive based on the number of viewings of the video segment, the user monitor module is to determine whether the number of viewings is less than a viewing threshold in a timeframe

In an embodiment, to determine that the user has become inattentive, the user monitor module 116 is to: obtain a biometric value of the user; compare the biometric value with a threshold value to determine whether the biometric value violates the threshold value; and determine that the user has become inattentive when the biometric value violates the threshold value. In various embodiments, the biometric value comprises at least one of: a body heat, a heart rate, or an eye activity. In other embodiments, the biometric value comprises a physical activity test. In a further embodiment, the physical activity test comprises finger tapping. The biometric value may be first obtained during an initialization phase where the user's baseline biometric may be determined. In this scenario, the threshold may be based on some percentage change or absolute change from the baseline. In other examples, the threshold may be based on some upper or lower limit of expected biometric values.

In an embodiment, to determine the user has become inattentive, the user monitor module 116 is to present the user a prompt and determine that the user incorrectly reacts to the prompt. For example, the prompt may be for the user to simply click an “OK” button in a dialog box to indicate that the user is present and paying attention. In a further embodiment, to determine that the user incorrectly reacts to the prompt, the user monitor module 116 is to determine that the user answered the prompt incorrectly. For example, the prompt may be a simple question such as “What day follows Wednesday?” If the user incorrectly answers “Friday,” then the user is likely inattentive. In another embodiment, to determine that the user incorrectly reacts to the prompt, the user monitor module 116 is to determine that the user failed to respond to the prompt in a threshold period of time. For example, if it takes the user two minutes to respond to the prompt, the user is likely inattentive. In an embodiment, the prompt comprises a quiz related to subject matter of the video segment.

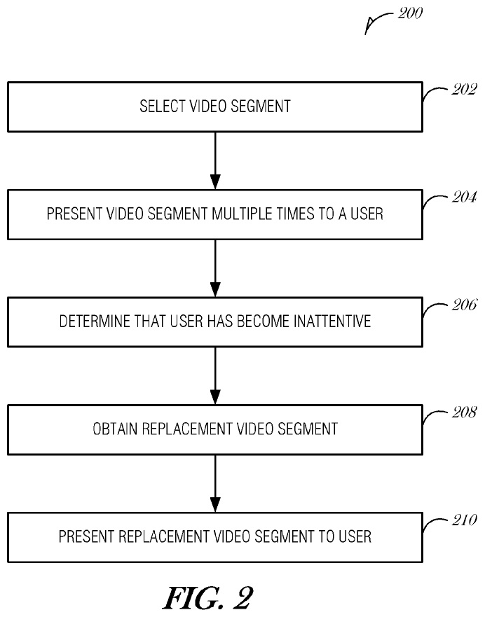

FIG. 2 is a flowchart illustrating a method 200 of delivering video to a viewer, according to an embodiment. At block 202, a video segment is selected from a plurality of video segments, the plurality of video segments including content of demonstrations of a skill.

At block 204, the video segment is presented multiple times to a user during a visual-based training session to train the user in the skill.

At block 206, it is determined that the user has become inattentive In an embodiment, determining that the user has become inattentive comprises accessing a history of viewings of the video segment and determining that the user has become inattentive based on the number of viewings of the video segment. In a further embodiment, the history of viewings comprises an identification of the video segment, a number of viewings of the video segment, and a frequency of the number of viewings in a recent timeframe. In a further embodiment, determining that the user has become inattentive based on the number of viewings of the video segment comprises determining whether the number of viewings is less than a viewing threshold in a timeframe. For example, if the user has viewed a segment fewer than three times in a week, then the user may be bored of the video.

In another embodiment, determining that the user has become inattentive comprises: obtaining a biometric value of the user; comparing the biometric value with a threshold value to determine whether the biometric value violates the threshold value; and determining that the user has become inattentive when the biometric value violates the threshold value. In a further embodiment, the biometric value comprises at least one of: a body heat, a heart rate, or an eye activity. In a further embodiment, the biometric value comprises a physical activity test. In a further embodiment, the physical activity test comprises finger tapping.

In another embodiment, determining the user has become inattentive comprises: presenting the user a prompt; and determining that the user incorrectly reacts to the prompt. In a further embodiment, determining that the user incorrectly reacts to the prompt comprises determining that the user answered the prompt incorrectly. In a further embodiment, determining that the user incorrectly reacts to the prompt comprises determining that the user failed to respond to the prompt in a threshold period of time. In a further embodiment, the prompt comprises a quiz related to subject matter of the video segment.

At block 208, a replacement video segment is obtained in response to determining that the user has become inattentive. In an embodiment, obtaining the replacement video segment comprises modifying the video segment.

In another embodiment, obtaining the replacement video segment comprises selecting the new video segment from the plurality of video segments. In a further embodiment, selecting the new video segment comprises: accessing a history of viewings of the video segment; and selecting the new video segment based on the history. In a further embodiment, the history of viewings comprises an identification of the video segment, a number of viewings of the video segment, and a frequency of the number of viewings in a recent timeframe. In such an embodiment, selecting the new video segment based on the history comprises: determining whether the number of viewings exceeds a viewing threshold; determining whether the frequency of the number of viewings in the recent timeframe exceeds a frequency threshold; and selecting the new video segment when the viewing threshold or the frequency threshold is violated. In a further embodiment, the recent timeframe comprises a month. In a further embodiment, the frequency threshold comprises one-thousand times in the month. In a further embodiment, the recent timeframe comprises a week. In a further embodiment, the frequency threshold comprises one-hundred times in the week.

In an embodiment, the history of viewings further comprises a duration of the number of viewings in the recent timeframe. In such an embodiment, selecting the new video segment based on the history comprises: aggregating the number of viewings, the frequency of the number of viewings in the recent timeframe, and the duration of the number of viewings in the recent timeframe to produce an aggregate value; and selecting the new video segment when the aggregate value exceeds a threshold. In a further embodiment, aggregating to produce the aggregate value comprises using a weighted function of the number of viewings, the frequency of the number of viewings in the recent timeframe, and the duration of the number of viewings in the recent timeframe. In a further embodiment, the weighted function implements a minimum number of frequency of the number of viewings in the recent timeframe before including the frequency of the number of viewings in the recent timeframe in the weighted function. In another embodiment, the weighted function implements a minimum number of duration of the number of viewings in the recent timeframe before including the duration of the number of viewings in the recent timeframe in the weighted function.

In an embodiment, the method 200 includes resetting the number of viewings to zero after selecting the new video segment. In an embodiment, the method 200 includes resetting the frequency of the number of viewings to zero after selecting the new video segment. In an embodiment, the method 200 includes resetting the duration of the number of viewings to zero after selecting the new video segment.

In an embodiment, selecting the new video segment from the plurality of video segments comprises: selecting a video segment from the plurality of video segments based on at least one of: a video style, a user preference, a time, a cultural consideration, or a cause of inattention. In another embodiment, selecting the new video segment from the plurality of video segments comprises: selecting a video segment from the plurality of video segments based on a mathematical calculation. In another embodiment, selecting the new video segment from the plurality of video segments comprises: selecting a video segment from the plurality of video segments based on a skill progression template.

At block 210, the replacement video segment is presented to the user.

In addition to using repeated viewings of a video to teach and reinforce a skill, a user may physically perform the skill in a controlled environment. The next section discusses various implementations that provide visual and audio feedback to a user who physically performs the skills.

Quantification and Comparison of User Motion with Idealized Model

In another example, a visual-based training system includes local user motion capture practice. The user may attempt a skill and a video capture system may record the attempt. The user may make repeated attempts at the skill and may improve the skill by this repeated practice. The local motion capture may be done after the user has viewed the skill performed by a professional. The local motion capture may also be done without first viewing the skill performed by a professional. A user viewing a professional performing a skill and local motion capture of a user performing a skill may be combined in a visual-based training system, such as by alternating sets of repetitions, or by using one until a certain proficiency is obtained by the user and then switching to the other. The user's motion may be captured by various mechanisms, such as with image analysis, using passive or active markers, using non-optical systems (e.g., use of gyroscopes, exoskeletons with potentiometers that articulate at the joints, or magnetic systems that detect markers susceptible to magnetic and electrical interference), etc.

In some cases, the user may perform the skill in an augmented reality (AR) environment where the user is provided visual feedback of the user performing the skill. For example, the user may perform a forehand swing for a tennis shot. The user's actions may be captured by a motion capture system and then a representation of the user may be presented back to the user in an AR system. By seeing himself perform the skill, the user may be able to discern incorrect form or areas to improve. The user's actions may be overlaid or presented next to a model form. The model form may be a professionally skilled performer or an amalgamate of skilled performers. The user's representation and the model form may be synchronized in time and posture to allow the user or another person (e.g., a coach) to view similarities and dissimilarities of the user's form in comparison to the model. In an AR system, the user may wear a glasses-based device to view the model form in a projected electronic image, which is translucent, allowing the user to see their own form, such as in a mirror or another projected image (either in the glasses-based device or on another screen).

Similar visual presentation and mimicking mechanisms may be implemented in a virtual reality (VR) system. In a VR system, the user may walk around the user's represented form or the model form in a way to view the action from a full 360 degrees around the subject or even in a universal view (e.g., 360 degrees around the equator of the viewing sphere and from all angles from +90 to −90 degrees). In order to present the user with the model, a proper model is needed. In order to create a model form, several mechanisms are described herein.

To create a model, a professional performer may be used as the template. However, one professional's form may be quite different from another professional's form, and each professional may have similar capabilities and effectiveness in their respective domains. As such, it is understood that there is no one absolute correct form due to differences in human biomechanics and body dimensions. Given this, various mechanisms may be used to obtain a model form to compare to the user's form.

One mechanism uses a weighted average of elite performers to create a model form. Skill models of professional or elite performers may be normalized to a standardized body type. This normalization may be used to account for different body types of the elite performers and to adjust to a model that more closely fits the user's body type for comparison purposes. After normalizing the body types of the professional or elite performers, the movement is time sliced and the performer that is most efficient for each time slice is used as the highest weighted input for the output model for that time slice.

The mechanism identifies most trends and reduces the number of required motion-captured elite performers by using a weighted average, where the weights are based on the reciprocal of the number of standard deviations from the mean of the 2nd derivative (delta of the delta) for each data point for all body segments for all performers. The result is that for each instant of the captured skill, the data that has the most influence is the data from the performer who was most efficiently producing and managing forces.

An ancillary mechanism is used to identify trends by considering the areas where certain performers have significant outlier motion or areas where a small number were highly convergent to the mean. Specifically, the ancillary mechanism may detect unusually high standard deviations in position values, second derivatives, or others, a smaller number of very large outliers for those same measurements, or, conversely, unusually high convergence across all expert performer samples in the group. These instances may reveal areas to emphasize in order to create an exaggerated proficiency in the model. To emphasize any of those areas, the mechanism may artificially add weight in the weighted average to the performers who execute it the outlier way for that moment in the skill where they exhibited that extra excellent body position. The mechanism then outputs a “final” model, which may optionally include the weights provided by the ancillary mechanism.

When comparing the user's form against the model form, an error signature may be derived. A mechanism may be used to quantitatively identify “error signatures” by calculating the difference between the position data in the user's attempt and the superior model for each frame (or some small period of time) of a video capture. These error signatures mimic the qualitative error signatures that are produced in a coach's brain as he observes a user. After identifying a set of error signatures (or seeing no significant ones), a coach has various decisions to make. Which one should I focus on? Should I offer corrections for more than one error at a time? Should I switch to a different exercise that will help to correct one of the errors? Is this user ready to progress to a more advanced skill?

The mechanisms described here build on traditional coaching processes. Using a priority-based system, certain error signatures will be given more weight in the priority system. This weight will be multiplied by the magnitude of the error signature. The highest output of this calculation among all possible error signatures for this skill will be the focus for the correction that the computerized coach will offer.

The weights may change over time as after more repetitions, certain corrections may become more important. After all output calculations of the weight multiplied by error signature magnitude calculations are below a certain threshold, the user may move on in the skill progression. Optionally, instead of a verbal/visual “correction”, a certain error signature may lead to an alternative exercise as an “intervention in the progression” in order to assist the body in making the correction in the present skill by mastering this additional exercise.

An error signature system builds on the quantitative mechanisms for storing a detailed model of a near-ideal performance of a skill. For each skill, common areas of errors are identified. For each of these, positional differences between the practicing user and the professional model are determined. The magnitude of such positional differences are also measured and constitute the essence of the error signature. Using equations, the positional errors are transformed into error values. Positional errors may be determined for a plurality of key body areas during a particular skill. For example, in a tennis swing, the hips, shoulders, racquet arm elbow, and racquet arm wrist positions may be tracked. Error values for these key body areas may be determined. The error values are then compared to one another and sorted by magnitude. The error value with the largest magnitude (e.g., the largest positional error) is then identified as the weakest portion of the skill. This portion of the skill may then be focused on using additional skill training. Error value prioritization is useful to prioritize training stages. If the magnitude of the largest error signature value is less than a threshold, then the skill may be considered to be within a certain range of acceptable performance. Once the user has mastered a skill, as evidenced by having all error values less than thresholds, then the user may progress to the next stage of training.

More specifically, each error signature has a set of parameters that defines how the error signature value is calculated. This set of parameters contains: 1) A set of body segments or joints whose position are measured on both the model's movement and the user's attempt to match the skill performed by the model; 2) A specific time within the model skill that is used to define the positions of joints or body segments for measurement of the distance from them to the corresponding joints or body segments on the user's attempt; and 3) A time range within which the positions are compared to identify a “best fit.” That best fit may give equal weight to all of the segments being measured or it may optimize an equation that sums those distances each multiplied by a coefficient designed to give more weight to more important body segments in this particular “best fit” analysis.

The time of the best fit may be at any point within the time range used for the best fit analysis. The time range may include the exact time being used to define the joint or body segment positions from which positional measurements are made. If the time of best fit is not close to this model time, then a timing error is identified. If the best fit provides positional distances that are sufficiently large in magnitude, then a positional error is identified.

In order to decide if a positional error or a timing error is more critical for this attempt, a weighting coefficient is applied to the time difference from the best fit time to the pre-selected model time to output a timing error value. This is then compared to an error signature value which is optimized during the best fit analysis to determine which is larger. The value of the larger one then becomes the error signature value for this specific “common” error in the skill for which the system is set up to detect.

The error signature values are then compared to all of other outputs for error signature analyses which are set up for this skill and fed into the sorting function described earlier. Finally, the largest error signature value will correspond to a specific error signature analysis that is set up and to either a timing error or a positional error. This information and potentially the magnitude of the error value is used as a guide in providing quantitative feedback, qualitative feedback, or both.

Error values may be presented to a user in a real time or semi-real time manner. Using the error values in a training session may provide the user the ability to attempt the skill a few times, then once with the measurements and error value calculations active, view the results, and continue performing and evaluating to gain proficiency.

Error signatures are essentially positional differences between an ideal model and a user's attempt. Error signatures may capture positional errors in 3D space, rotational positional errors, joint angle positional errors, or combinations thereof.

Although error signatures are useful, in some embodiments, a temporal forgiveness is used to adjust for timing issues. For example, a user may have good joint positions in a first part of a skill and a second part of the skill, but the timing may be off (too slow or too fast), such that when compared with the ideal model, either the first position or the second position appears to be poorly matched. However, if the problem is not positioning, but instead the timing, temporal forgiveness may be used to identify a best fit between the user's execution of a skill and the model and then obtain error signatures at the best fit time. If the best fit positional analysis provides that the positional errors are minimal, then the system may notify the user of a timing error as opposed to a positional error. The system may further recommend exercises or activities to correct the timing error.

Error signatures may scale with the level of training. For example, beginner users may present larger error signatures than advanced users. As another example, error signatures of particular parts or portions of a body may be used in a training regimen. A series of stages that start with a large temporal forgiveness and a large positional forgiveness may stepwise progress to smaller temporal and positional forgiveness values. Additionally, the stages may initially focus on large body motions (e.g., core rotation in a tennis swing) and progress to more specific body motions (e.g., wrist release in a tennis swing).

Error signatures and error values may be useful to direct skill progression, subskill selection for specific improvements, and general feedback.

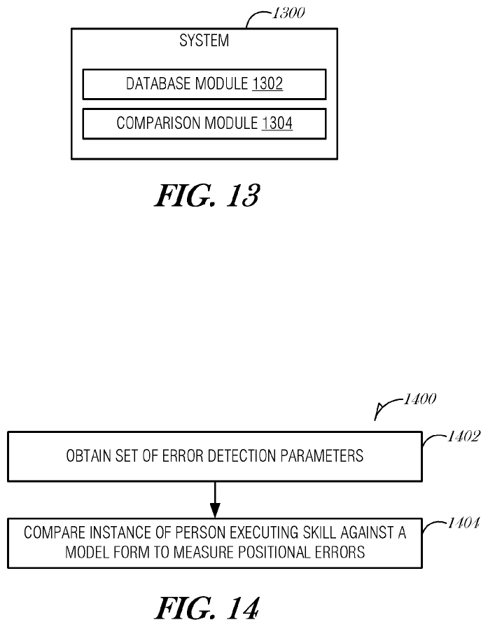

FIG. 13 is a block diagram illustrating a system 1300 for error detection and prioritization, according to an embodiment. The system 1300 may include a database module 1302 and a comparison module 1304.

The database module 1302 may be configured to access an error detection database to obtain a set of error detection parameters, each error detection parameter describing a position of a person during execution of a physical skill, the execution having an execution timeframe. In an embodiment, the position of the person during execution of the physical skill comprises a joint position or a limb position.

The comparison module 1304 may be configured to compare an instance of the person during execution of the physical skill against a model form to measure positional errors of the instance of the person during execution of the physical skill with respect to the model form. In an embodiment, the model form represents an ideal execution of the physical skill.

In an embodiment, each of the error detection parameters are respectively associated with a time range in the execution timeframe of the physical skill. In a further embodiment, measuring positional errors of the instance of the person with respect to the model form for a particular error detection parameter is performed in the time range associated with the particular error detection parameter. In an embodiment, the error detection parameters are matched to a position of the model form in an attempt to find a best fit in the time range interval. The best fit is then used to determine positional or timing errors of the instance of the person with respect to the model form.

In an embodiment, the error detection parameters correspond to joint positions, limb positions, or body positions during the execution of the physical skill.

In an embodiment, the system 1300 is configured to sort positional errors of the instance of the person with the model form.

In an embodiment, the system 1300 is configured to identify the largest positional error based on the sorted positional errors and notify a user of the largest positional error.

In an embodiment, the system 1300 is configured to obtain a training routine from a skills database based on the largest positional error and present the training routine to the user.

In an embodiment, the system 1300 is configured to determine that positional errors of the instance of the person with the model form are each less than a threshold and notify a user that the instance of the person during execution of the physical skill was a successful performance. After successfully completing performance of a skill, the person may progress to a more advanced skill, move laterally to a related skill, or work further on mastering the current skill.

FIG. 14 is a flowchart illustrating a method 1400 of error detection and prioritization, according to an embodiment. At block 1402, an error detection database is accessed to obtain a set of error detection parameters, each error detection parameter describing a position of a person during execution of a physical skill, the execution having an execution timeframe. In an embodiment, the position of the person during execution of the physical skill comprises a joint position or a limb position.

At block 1404, an instance of the person during execution of the physical skill is compared against a model form to measure positional errors of the instance of the person during execution of the physical skill with respect to the model form. In an embodiment, the model form represents an ideal execution of the physical skill.

In an embodiment, each of the error detection parameters are respectively associated with a time range in the execution timeframe of the physical skill. In a further embodiment, measuring positional errors of the instance of the person with respect to the model form for a particular error detection parameter is performed in the time range associated with the particular error detection parameter.

In an embodiment, the error detection parameters correspond to joint positions, limb positions, or body positions during the execution of the physical skill.

In an embodiment, the method 1400 includes sorting positional errors of the instance of the person with the model form.

In an embodiment, the method 1400 includes identifying the largest positional error based on the sorted positional errors and notifying a user of the largest positional error. In a further embodiment, the method 1400 includes obtaining a training routine from a skills database based on the largest positional error and presenting the training routine to the user.

In an embodiment, the method 1400 includes determining that positional errors of the instance of the person with the model form are each less than a threshold and notifying a user that the instance of the person during execution of the physical skill was a successful performance.

### Skill Development in Virtual Reality

VR provides real-life simulation of environmental conditions to improve read and react skills or other athletic skills. VR may also be used in a different manner, where VR is used for visual-based training in areas of divergence and convergence, tracking, and recognition of timing in order to optimize responses to visual cues. Such visual-based training is useful for any sport that requires hand-eye coordination, such as baseball, hockey, tennis, badminton, ping pong, basketball, or the like.

In addition to observing model form in a VR system, other skills may be practiced separately or integrated into an overall training plan. One skill that may be practiced in VR is a divergence to convergence vision training skill. Another skill that may be practiced is head tracking and yet another skill that may be practiced is timing. In a baseball swing, all three skills are important as the ball moves toward the batter, the batter's divergence to convergence eye adjustment, head position, and timing all need to act in concert to achieve the optimum swing.

In an embodiment, a quick change between divergent vision with pupillary dilatation and convergent vision with pupillary constriction is simulated in a VR system. A user wearing a VR headset is first presented a blackout visual interface, e.g., total darkness. Then the virtual environment is instantly transitioned to a lighted field and the user is prompted to track or hit an object, either virtually or with a real implement. For example, a user may use a baseball bat to attempt to hit a baseball on a tee. The user's bat may be represented electronically in the virtual world. Use of a real bat may allow the user to work on form or feel the athletic gear. The VR system may continue simulating turning the lights off and on in a room or environment. The blackout with sudden light will train the brain to move quickly between the different types of vision through pupillary manipulation. Essentially the system will minimize the time it takes for the user to focus on the changing visual cues of a moving object, such as a pitched baseball, with subsequent improvement in read and react skills.

For improvements in head tracking, the user may be prompted to move their head so the object (e.g., ball) is squared in their vision throughout the object's path. For example, when a pitch is released, the VR system may measure the user's reaction time and the user's head position as the baseball moves up to the point of contact with the bat. Using this type of training, the “head on the ball” skill is reinforced to improve hitting. VR headsets are ideal because they track head movement. The VR headset is used to track the head position throughout the entire path of the pitch with feedback provided to the user regarding their variance from the ideal head position based on the location of the oncoming ball. This feedback may be in real-time with visual and/or audio cues or through playback analysis at the completion of a pitch. Feedback might include both head position for various increments of the approaching pitch as well as upon impact. In this situation head tracking is ideal for visual tracking which is largely a function of head location, but would also be useful to improve the ability of going quickly from divergent vision to convergent vision.

The last element that may be trained is timing. Being able to recognize the proper timing for the swing of a bat is yet another important component for an optimal swing. The VR system may measure spatial locations for a pitch and provide the user with visual and/or audio cues as to the optimal time for contact. If a hitter can wait to swing until the very last moment for each type of pitch delivered, the swing will be quicker and more powerful by maintaining a compact, non-reaching body position. In addition, the user may be provided haptic feedback, such as through an electronic bat or other hitting apparatus, to indicate the impact location of the object (e.g., baseball) on the hitting apparatus (e.g., electronic bat). This may allow the user to better determine whether their swing was early or late or whether the swing plane was accurate.

In summary, the VR system is highly effective in providing a user (e.g., baseball hitter) with training in three key visual areas: (1) divergent to convergent vision, (2) head tracking, and (3) visual recognition for timing. These visual-based training mechanisms may be combined with video repetitions for observational learning of a certain skill in order to provide a unique and powerful training program.

It is understood that the visual-based training for improvements in read and react tasks related to divergence and convergence, head tracking, recognition of timing, and similar areas of visual effectiveness may be applied for other sports or motor control performances. For example, activities like catching a football or blocking a puck may benefit from improving divergence to convergence vision, head tracking and/or eye tracking, or visual recognition for timing.

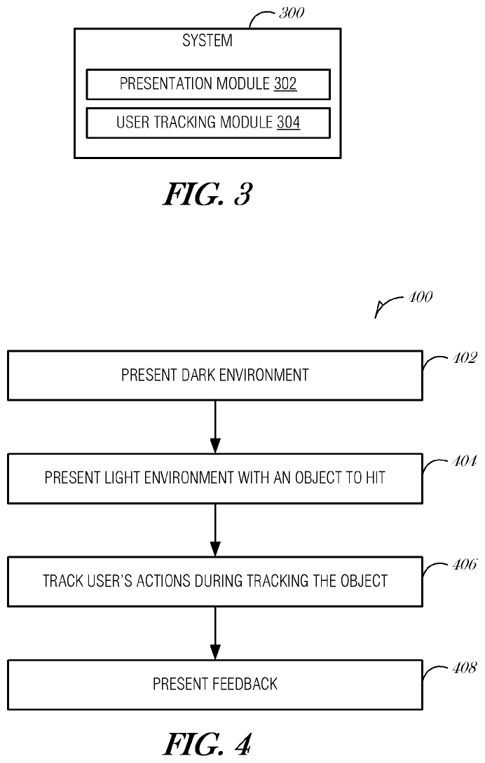

FIG. 3 is a block diagram illustrating a system 300 for visual-based training, according to an embodiment. The system includes a presentation module 302 and a user tracking module 304. The presentation module 302 is configured to present a dark environment to a user in a virtual reality environment, the user equipped with a virtual reality headset. In an embodiment, the dark environment comprises a projected dark field. In a further embodiment, the projected dark field is presented on translucent eyeglasses worn by the user.

Later, the presentation module 302 presents a lighted scene to the user, the lighted scene including an object for the user to track. In an embodiment, the object is a baseball. In an embodiment, the lighted scene comprises a baseball pitch, and to track the user's actions, the user tracking module 304 is to track a virtual bat being held by the user. Alternatively, the lighted scene may comprise a baseball pitch, and to track the user's actions, the user tracking module 304 is to track a physical bat being held by the user. In another embodiment, the lighted scene comprises a baseball pitch, and to track the user's actions, the user tracking module 304 is to track head movement during the baseball pitch. In any of these embodiments, to provide feedback, the presentation module 302 may present the user's body position at a point in time during the baseball pitch. For example, in an embodiment, to present the user's body position, the presentation module 302 is to present a head position of the user at the point of contact. As another example, in an embodiment, to present the user's body position, the presentation module 302 is to present a head position of the user at points in time during the approach of a baseball during the baseball pitch. The user's body may be represented as a 3D model, wireframe model, stick figure, or other representation to show the user the user's head position at various times during the approach of the baseball. In a VR environment, camera angles may be changed to view the user's avatar from various perspectives. The user's activity may be recorded so that the user's performance may be played back, paused, reversed, or stepped through frame-by-frame.

In an embodiment, the object is a tennis ball. In such an embodiment, the lighted scene may comprise a tennis serve, and to track the user's actions, the user tracking module 304 is to track a virtual racquet being held by the user. Alternatively, the user tracking module 304 is to track a physical racquet being held by the user. In another embodiment, the lighted scene may comprise a tennis serve, and to track the user's actions, the user tracking module 304 is to track head movement during the tennis serve. In an embodiment, to provide feedback, the presentation module is to present the user's body position at a point in time during the tennis serve. In a further embodiment, to present the user's body position, the presentation module is to present a head position of the user at a point of contact. In a further embodiment, to present the user's body position, the presentation module is to present a head position of the user at points in time during the approach of a tennis ball during the tennis serve.

Other sports or activities may be trained using divergent/convergent exercises, head tracking, or timing. Thus, in an embodiment, the object is a generic target. For example, the object may be a ball-like object, a cubed-shaped object, a disc-shaped object, a fist-shaped object, or the like. Further, some activities may use body parts as objects, such as martial arts training. The object may be hit, caught, blocked, dodged, or deflected in various sports or activities.

In an embodiment, the lighted scene comprises a martial arts situation, and to track the user's actions, the user tracking module 304 is to track a martial arts action by the user. In an embodiment, the martial arts action comprises a block or a dodge.

In an embodiment, the lighted scene comprises a martial arts situation, and to track the user's actions, the user tracking module 304 is to track head movement during martial arts situation.

The user tracking module 304 tracks the user's actions while the user tracks the object. In response, the presentation module 302 provides feedback to the user based on the user's actions. In an embodiment, to provide feedback, the presentation module 302 is to present the user's body position at a point in time while the user is visually tracking the object. In a further embodiment, to present the user's body position, the presentation module 302 is to present a head position of the user at the point of contact during the user tracking the object.

FIG. 4 is a flowchart illustrating a method 400 of visual-based training, according to an embodiment. At block 402, a dark environment is presented to a user in a virtual reality environment, the user equipped with a virtual reality headset. In an embodiment, the dark environment comprises a projected dark field. For example, the user may be presented an entirely black picture to effectively render the user blind. In an embodiment, the projected dark field is presented on translucent eyeglasses worn by the user.

At block 404, a lighted scene is presented to the user, the lighted scene including an object for the user to track. In an embodiment, the object is a baseball. In the baseball context, several things may be simulated and used for training. In an embodiment, the lighted scene comprises a baseball pitch, and tracking the user's actions comprises tracking a virtual bat being held by the user. Alternatively, tracking the user's actions comprises tracking a physical bat being held by the user.

In an embodiment, the lighted scene comprises a baseball pitch, and tracking the user's actions comprises tracking head movement during the baseball pitch.

At block 406, the user's actions are tracked while the user tracks the object.

At block 408, feedback is provided to the user based on the user's actions. Feedback in the baseball context is discussed first. In an embodiment, providing feedback comprises presenting the user's body position at a point in time during the baseball pitch. In an embodiment, presenting the user's body position comprises presenting a head position of the user at the point of contact. In an embodiment, presenting the user's body position comprises presenting a head position of the user at points in time during the approach of a baseball during the baseball pitch.

Presentation, tracking, and feedback may be in other contexts, such as tennis. Thus, in an embodiment, the object is a tennis ball. In an embodiment, the lighted scene comprises a tennis serve, and tracking the user's actions comprises tracking a virtual racquet being held by the user. Alternatively, the user may use a physical racquet. In an embodiment, the lighted scene comprises a tennis serve, and tracking the user's actions comprises: tracking head movement during the tennis serve. In an embodiment, the method includes presenting the user's body position at a point in time during the tennis serve. In a further embodiment, presenting the user's body position comprises presenting a head position of the user at the point of contact. In a further embodiment, presenting the user's body position comprises presenting a head position of the user at points in time during the approach of a tennis ball during the tennis serve.

Other types of activities may be presented and tracked. Thus, in an embodiment, the object is a generic target. As a further example, martial arts may be trained in a similar manner. In an embodiment, the lighted scene comprises a martial arts situation, and tracking the user's actions comprises: tracking a martial arts action by the user. In a further embodiment, the martial arts action comprises a block or a dodge.

In an embodiment, the lighted scene comprises a martial arts situation, and tracking the user's actions comprises: tracking head movement during martial arts situation.

In an embodiment, providing feedback comprises: presenting the user's body position at a point in time while the user is visually tracking the object. In a further embodiment, presenting the user's body position comprises presenting a head position of the user at the point of contact with the object.

FIG. 18 is a block diagram illustrating a system 1800 for visual-based training, according to an embodiment. The system 1800 includes a presentation module 1802 and a user tracking module 1804. The presentation module 1802 may be configured to present an environment to a user in a virtual reality environment and present a scene to the user in the environment, the scene including an object for the user to visually track.

The user tracking module 1804 may be configured to track the user's head movement while the user visually tracks the object. The presentation module 1802 may then provide feedback to the user based on the user's head movement.

In an embodiment, the object is a baseball, and wherein the scene includes a baseball pitch, and the user tracking module 1804 is configured to track the user's head movement while the user tracks the baseball during the baseball pitch.

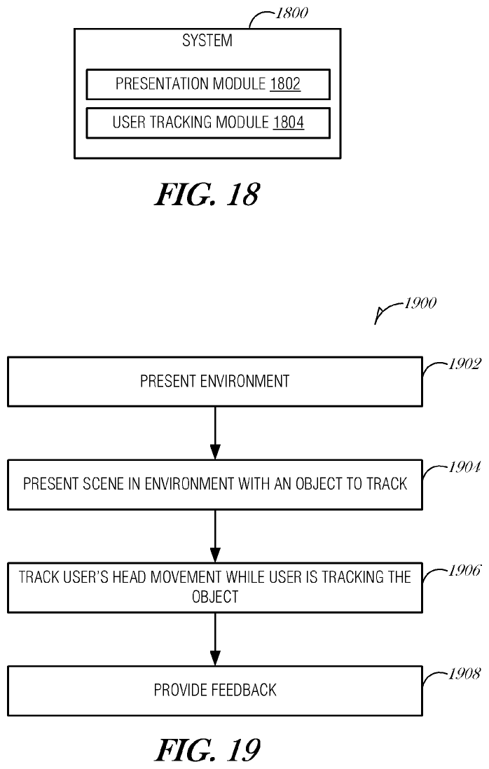

FIG. 19 is a flowchart illustrating a method 1900 of visual-based training, according to an embodiment. At block 1902, an environment is presented to a user in a virtual reality environment. At block 1904, a scene is presented to the user in the environment, the scene including an object for the user to visually track. At block 1906, the user's head movement is tracked while the user visually tracks the object. At block 1908, feedback is provided to the user based on the user's head movement.

In an embodiment, the object is a baseball, and wherein the scene includes a baseball pitch, and tracking the user's head movement is performed while the user tracks the baseball during the baseball pitch.

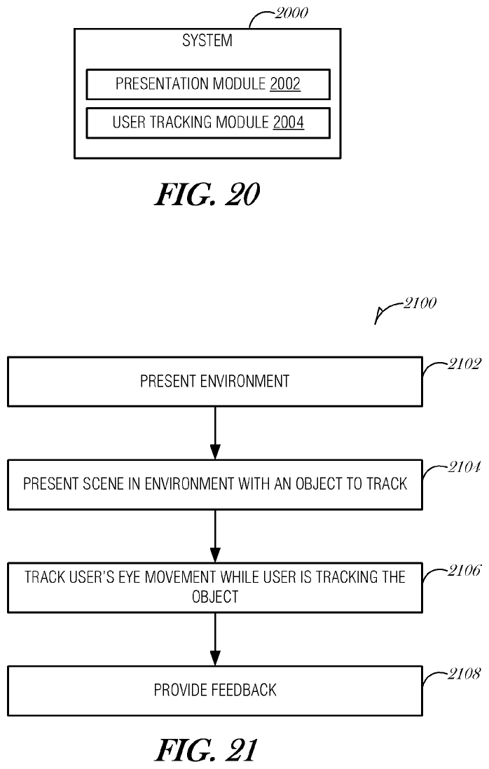

FIG. 20 is a block diagram illustrating a system 2000 for visual-based training, according to an embodiment. The system 2000 includes a presentation module 2002 and a user tracking module 2004. The presentation module 2002 may be configured to present an environment to a user in a virtual reality environment and present a scene to the user in the environment, the scene including an object for the user to visually track. The user tracking module 2004 may be configured to track the user's eye movement while the user visually tracks the object. The presentation module 2002 may then provide feedback to the user based on the user's eye movement.

In an embodiment, the object is a baseball, and wherein the scene includes a baseball pitch, and the user tracking module 2004 is to track the user's eye movement while the user tracks the baseball during the baseball pitch.

FIG. 21 is a flowchart illustrating a method 2100 of visual-based training, according to an embodiment. At block 2102, an environment is presented to a user in a virtual reality environment. At block 2104, a scene is presented to the user in the environment, the scene including an object for the user to visually track. At block 2106, the user's eye movement is tracked while the user visually tracks the object. At block 2108, feedback is provided to the user based on the user's eye movement.

In an embodiment, the object is a baseball, and wherein the scene includes a baseball pitch, and tracking the user's eye movement is performed while the user tracks the baseball during the baseball pitch.

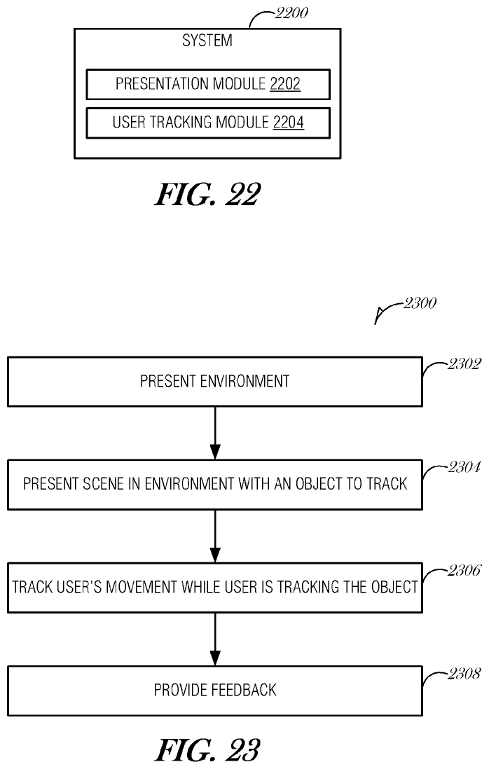

FIG. 22 is a block diagram illustrating a system 2200 for visual-based training, according to an embodiment. The system 2200 includes a presentation module 2202 and a user tracking module 2204. The presentation module 2202 may be configured to present an environment to a user in a virtual reality environment and present a scene to the user in the environment, the scene including an object for the user to visually track. The user tracking module 2204 may be configured to track a user's movement while the user visually tracks the object. The presentation module 2202 may then provide feedback to the user based on the user's movement.

In an embodiment, the object is a baseball, the scene includes a baseball pitch, the user tracking module 2204 is to track the user's attempt to hit the baseball during the baseball pitch, and the presentation module 2202 is to provide timing information regarding the user's attempt to hit the baseball.

In a further embodiment, the timing information includes a visual or audio cue indicating a time to begin the attempt to hit the baseball. In another embodiment, the timing information includes information of the user's performance compared to a model performance.

FIG. 23 is a flowchart illustrating a method 2300 of visual-based training, according to an embodiment. At block 2302, an environment is presented to a user in a virtual reality environment. At block 2304, a scene is presented to the user in the environment, the scene including an object for the user to visually track. At block 2306, the user's movement is tracked while the user visually tracks the object. At block 2308, feedback is provided to the user based on the user's movement.

In an embodiment, the object is a baseball, and the scene includes a baseball pitch, and tracking the user's movement includes tracking the user's attempt to hit the baseball during the baseball pitch, and providing feedback includes providing timing information regarding the user's attempt to hit the baseball.

In a further embodiment, the timing information includes a visual or audio cue indicating a time to begin the attempt to hit the baseball. In another embodiment, the timing information includes information of the user's performance compared to a model performance.

### Subskills Detection and Skills Drills

In an example, a visual-based training system includes automated progression analysis. Using an algorithm, a computer may determine whether a user has obtained a minimum proficiency in a skill or subskill. If the user has obtained a minimum proficiency, the user may be automatically progressed to a new skill or subskill, to a new level of difficulty in the current skill or subskill, to a new, more advanced, skill drill type which will still focus on the same skill or subskill, or some combination thereof. The automated progression may include an increase in complexity of skills or subskills as a user progresses. The automated progression analysis may be used with the video repetition, the local user motion capture, skill practicing, or any of the other mechanisms described herein. The automated progression analysis may include a linear or a parallel track for some specified skills or subskills. A subskill may be a part of more than one skill. If a user obtains proficiency in a specified subskill and the specified subskill is implicated in more than one skill, the user may be automatically progressed along a progression path in all of the skills that are implicated by the subskill.

Subskill progression may be automated or semi-automatic. Part of subskill progression includes identifying and classifying subskills, and then combining the identified subskills into a progression routine to train or learn a compound skill based on the subskills.

Subskills may be identified by using motion capture mechanisms. The base level of movement consists of single muscle contractions. Muscles have three functions: they can extend a body segment, they can flex a body segment back toward the body, or they can rotate a body segment. Using a set of conditions for the first derivatives of the positional data of body segments a system is able to identify these base-level movements.

Each skill is built as a combination of base-level skills, which may be used to identify and code the quantitative signature. This signature is encoded as a set of base movements involved in the combined skill plus the timing in which each base movement was seen. These combined movements and their signatures become a new skill in the progression of a discipline. This mechanism may be iterated to identify more complex movements in the discipline.

Then each skill built as a combination of those base level skills becomes a model for which the system may identify and code as the quantitative signature. This signature may be encoded as a set of base movements involved in the combined skill plus the timing when each base movement occurred. These combined movements and their signatures may become a new skill in the progression of a discipline and may be defined as a new skill (and subskill) for the given discipline. Additionally searching may be performed to identify signatures in more complex motion-captured models. These more complex motion-captured models represent more complex movements in the discipline.

Iterating this process of identifying skill signatures and analyzing increasingly complex models, reveals the layers of complexity. Part of the analysis attempts to identify the signatures in any of the rest of the skills in the discipline already identified as well as base human movements. By doing so, the system may identify the components that make up each skill. In the end, the complex web of interconnected skills that make up a movement skill are revealed.

Relationships that connect subskills to skills that they contribute to illustrate opportunities to build new pathways which constitute skill development progressions. These pathways ultimately form as sequential steps, generally from simple skills to complex skills within a single sport or other movement-skill based discipline. The subskill detection system is able to perform analyses on each movement skill within a discipline in order to attempt to detect the presence of subskills within each skill.

This may be an iterative process because new movement skills may be detected, which haven't yet been captured but should be captured to expand the set on which the analysis is performed. However, once a user is satisfied that all relevant skills in a discipline have been analyzed (each of which may also be subskills for still more complex skills), the user will have a rich and deep understanding of the underlying interconnectivity between the skills of a discipline and thus understand with a mathematical and scientific basis what skills are more fundamental. Fundamental skills are ones that more complex skills are built from.

Benefits of this deep understanding of the skill-interconnectivity of the discipline may include better skill development progressions implemented within the discipline, better ability for coaches to identify limiting factors in player's skills by understanding deficiencies in subskills, a data set that research institutions may want to query to better understand motor skill brain structures and motor skill acquisition processes and, potentially, a movement skill search engine for the masses to use for entertainment or learning. It is useful to know which skills in a discipline are components of a plurality of more complex skills that will eventually be learned. These are ones that it is worth working on to near mastery.

Every possible interconnection may not be necessary, so each time the analysis is executed, the subskills that are detected may be presented to a user (e.g., a technician) who then chooses the subskills that apply. This filters false readings. The remaining subskills may be separated into base-level human movements in one menu and combined movements from within the movement skill in another menu. These menus also identify the time during the skill where the subskill was present.

Each subskill may be reduced to a skill code. A skill code may be a group of measurements indicating position, angle, velocity, acceleration, or the like, of a joint or multiple joints used in a skill or subskill. The skill code may also have a temporal aspect indicating the time relative to the start of the skill or subskill, in which the particular position, angle, velocity, etc. is observed. The skill code may be abstracted to a numerical or alphanumerical representation to make referring to skill codes easier for end users.

An interrelated web of skill codes may be used by a user (e.g., coach) to view a skill and all of the subskills. Such an overview of a skill is useful for teaching or instruction. For example, the final output may be a web of interconnections that reveals how skills should be developed with certain skill drills during the human learning process. This also allows the user (e.g., coach) to make sure that all of the subskills have been captured for later use.

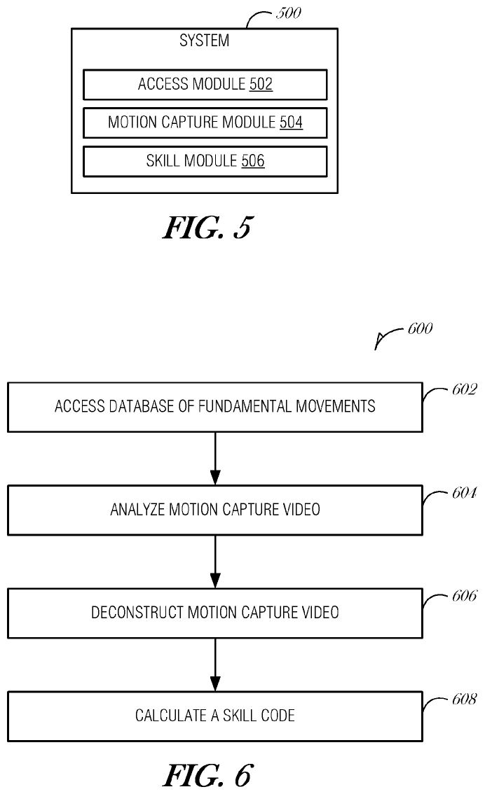

FIG. 5 is a block diagram illustrating a system 500 for subskill classification, according to an embodiment. The system 500 includes an access module 502 to access a database of fundamental movements, each fundamental movement being uniquely identified with a corresponding identifier. Fundamental movements include simply muscle contractions that result in a body movement. One example of a fundamental movement is the flexion of a bicep muscle, which would draw the person's hand toward the person's shoulder. The extension of the arm, using the triceps muscle, may be another fundamental movement. Each fundamental movement may be uniquely identified, such as with an internal identifier in the database.

The system 500 also includes a motion capture module 504 to analyze a motion capture video of an execution of a skill being performed. The motion capture video may be deconstructed by the motion capture module 504, to identify a subset of fundamental movements that are used during the execution of the skill, the subset of fundamental movements from the database of fundamental movements. In an embodiment, the fundamental movements are selected from movements comprising: a joint flexion, a joint extension, or a joint rotation.

The system 500 may also include a skill module 506 to calculate a skill code, the skill code representing the skill and based on identifiers corresponding to the subset of fundamental movements

The system 500 may include a presentation module to present the skill code to a user. In a further embodiment, to present the skill code the presentation module is to present the skill code with a plurality of other skill codes in an interrelated web of skill codes.

FIG. 6 is a flowchart illustrating a method 600 of subskill classification, according to an embodiment. At block 602, a database of fundamental movements is accessed, each fundamental movement being uniquely identified with a corresponding identifier.

At block 604, a motion capture video of an execution of a skill being performed is analyzed. At block 606, the motion capture video is deconstructed to identify a subset of fundamental movements that are used during the execution of the skill, the subset of fundamental movements from the database of fundamental movements.

At block 608, a skill code is calculated, the skill code representing the skill and based on identifiers corresponding to the subset of fundamental movements.

In an embodiment, the fundamental movements are selected from movements comprising: a joint flexion, a joint extension, or a joint rotation.

In an embodiment, the method 600 includes presenting the skill code to a user. In a further embodiment, presenting the skill code comprises: presenting the skill code with a plurality of other skill codes in an interrelated web of skill codes. The interrelated web of skill codes may be used by an operator to view a skill and all of the subskills. Such an overview of a skill is useful for teaching or instruction. For example, the final output may be a web of interconnections that reveals how skills should ideally be built during the human learning process for a particular discipline. This also allows the operator to make sure that all of the subskills have been captured for later use in a “complete” teaching process.

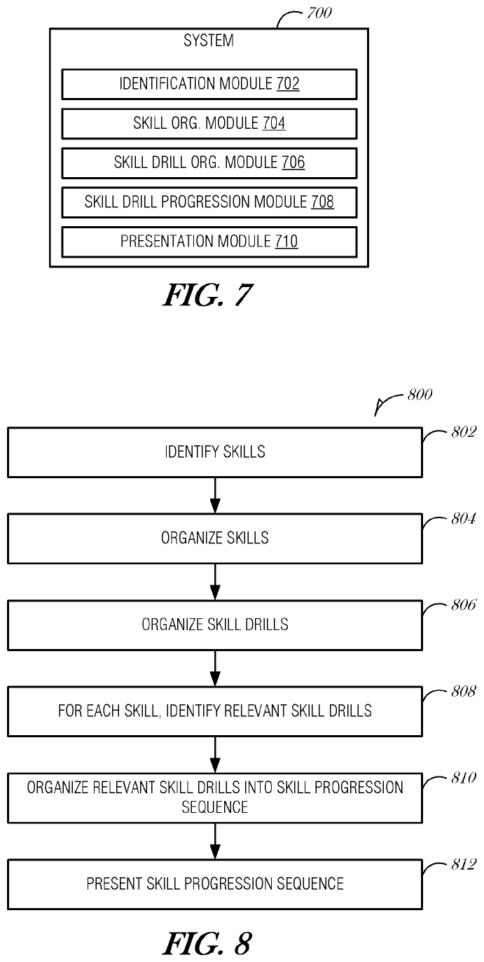

Using the skill codes or other portions of the analysis from method 600, a skill progression may be defined. FIG. 7 is a block diagram illustrating a system 700 for defining a skill progression, according to an embodiment. The system 700 includes an identification module 702 to identify a plurality of skills of a physical activity, and a skill organization module 704 to organize the plurality of skills from more simple skills to more complex skills. The system 700 also includes a skill drill organization module 706 to organize a plurality of skill drills from drills that involve larger body parts to drills that involve smaller body parts; and for each of the plurality of skills, identifying relevant skill drills from the plurality of skill drills. A skill drill progression module 708 organizes the relevant skill drills into a skill progression sequence, the skill progression sequence including a subset of the plurality of skill drills for a skill from the plurality of skills. A presentation module 710 presents the skill progression sequence.

A skill is a movement related to one or more sports or activities. Example skills include, but are not limited to running, jumping, throwing a ball, swinging a stick or bat, etc. Skills may also refer to more simplified movements, such as arm use during running or jumping, weight transfer during throwing, or the like. Several simpler skills may combine to a complex skill. A skill drill is an exercise that provides practice of one or more skills. Skills may also be referred to as subskills.

In an embodiment, the physical activity includes hockey.

In an embodiment, the physical activity includes hockey, and the plurality of skills includes ice skating, shooting, stickhandling, and checking.

In an embodiment, the physical activity includes hockey, wherein the skill includes ice skating, and wherein the plurality of skill drills comprises posture exercises, leg motion exercises, and arm motion exercises.

In an embodiment, the physical activity includes hockey, wherein the skill includes shooting, and wherein the plurality of skill drills comprises weight transfer exercises, stick position exercises, and hand position exercises.

In an embodiment, the physical activity includes hockey, wherein the skill includes stickhandling, and wherein the plurality of skill drills comprises wrist roll exercises, peripheral vision exercises, and lower hand exercises.

In an embodiment, the skill drills are based on observational learning, visualization, posing, rapid posing, slow motion mimicking, or full speed mimicking.

One way to understand skill progression is from simple movements to the complex skills specific to a given discipline as a path through a 2-dimensional array of concepts. One dimension includes the skills organized from simple to most complex. On another dimension are drills to help to develop a particular skill. Within each skill, drills are organized to get the largest body parts and most gross movements on track first and then work toward the fine details. Generally, the path works through a set of drills for the simplest skill first and then work through drills for the next skill that would be slightly more advanced or more complicated. In some cases, the performer may want to try to work different skills in parallel, so the system may diverge from this simple progression into a more complex one that “samples” drills for a more diverse set of skills in a fashion that mixes their development within the same time frame.

A skill progression may also be organized as a series of “courses” with pre-requisites. There may be a base-level or “introductory” course for a given discipline that is a pre-requisite for the rest. Then the user may have options on what courses to pick. Here though, the first level courses for specific areas of the discipline (e.g. in Hockey, Skating, Shooting, Stickhandling) would be pre-requisites for advanced courses.

It is understood that a rewards system may help a user pay more attention and retain more training. Thus, in some embodiments, the skills use aspects of gamification. Thus, in an embodiment, the presentation module 710 is to determine a gamification theme and present the skill progression sequence using the gamification theme.

FIG. 8 is a flowchart illustrating a method 800 of defining a skill progression, according to an embodiment. At block 802, a plurality of skills of a physical activity is identified. At block 804, the plurality of skills are organized from more simple skills to more complex skills. At block 806, a plurality of skill drills are organized from drills that involve larger body parts to drills that involve smaller body parts. At block 808, for each of the plurality of skills, relevant skill drills are identified from the plurality of skill drills. At block 810, the relevant skill drills are organized into a skill progression sequence, the skill progression sequence including a subset of the plurality of skill drills for a skill from the plurality of skills. At block 812, the skill progression sequence is presented.

In an embodiment, the physical activity includes hockey.

In an embodiment, the physical activity includes hockey, and the plurality of skills includes ice skating, shooting, stickhandling, and checking.

In an embodiment, the physical activity includes hockey, wherein the skill includes ice skating, and wherein the plurality of skill drills comprises posture exercises, leg motion exercises, and arm motion exercises. Posture may be practiced on ice or off ice. Posture refers to the user's posture during each phase of a skating stride (e.g., load, push, recovery). Leg motion exercises may be used to emphasize or practice the correct push or recovery during a skating stride. Similarly, arm motion exercises may be used to practice the correct form in the various stages of the stride.

In an embodiment, the physical activity includes hockey, wherein the skill includes shooting, and wherein the plurality of skill drills comprises weight transfer exercises, stick position exercises, and hand position exercises. Weight transfer exercises may be practiced with or without a stick and emphasize the movement of the user's bodyweight from their back foot to their front foot. Such action will increase the momentum and power behind the stick movement during a shot. Stick position and hand position exercises may emphasis or practice the various positions during the execution of a particular shot. It is understood that the stick and hand positions may be different for different shots (e.g., wrist shot versus slap shot).

In an embodiment, the physical activity includes hockey, wherein the skill includes stickhandling, and wherein the plurality of skill drills comprises wrist roll exercises, peripheral vision exercises, and lower hand exercises. Skill drills may build on each other in a particular category of drills. For example, an athlete may first practice wrist roll exercises with the upper hand, then the lower hand, then both hands to get a better feeling of how the stick moves and how the hands should be positioned during stickhandling.

In an embodiment, the skill drills are based on observational learning, visualization, posing, rapid posing, slow motion mimicking, or full speed mimicking.

In an embodiment, the method 800 includes determining a gamification theme and presenting the skill progression sequence using the gamification theme.

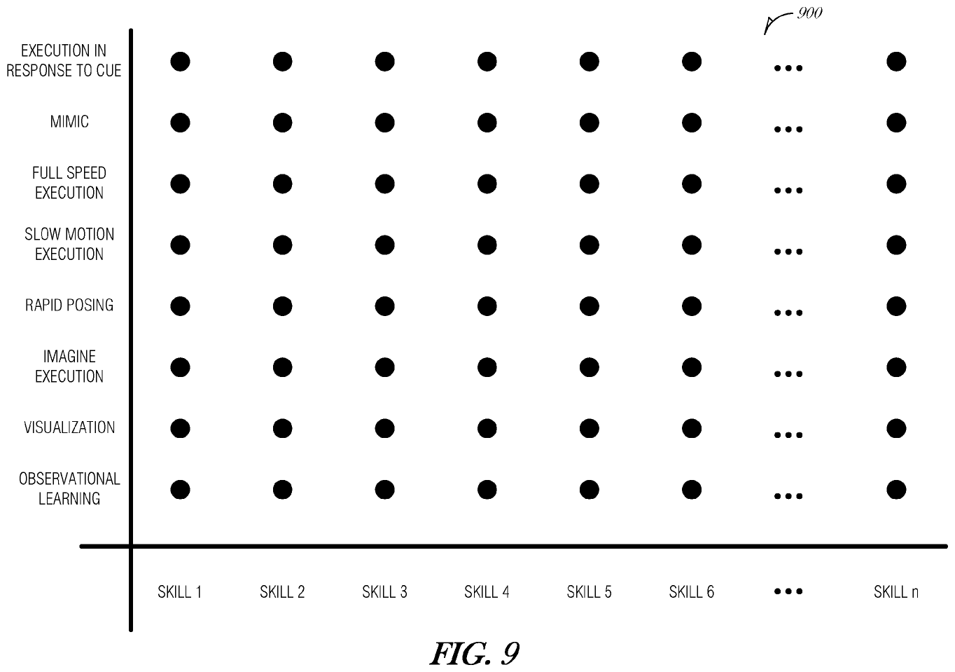

FIG. 9 is an example of a skill drill matrix 900, according to an embodiment. Skills are arranged on the x-axis from more simple (on the left) to more complex (on the right). Skill drill types are arranged on the y-axis from Observational Learning (on the bottom) to Skill Execution in Response to Relevant Sensory Cue (on the top). The order and arrangement of the skill drill types are not limiting. Any order or arrangement may be used according to a system designer, coach, user, or other person's preference. Each dot in the matrix represents one or more specific skill drills for a skill-skill drill type combination.

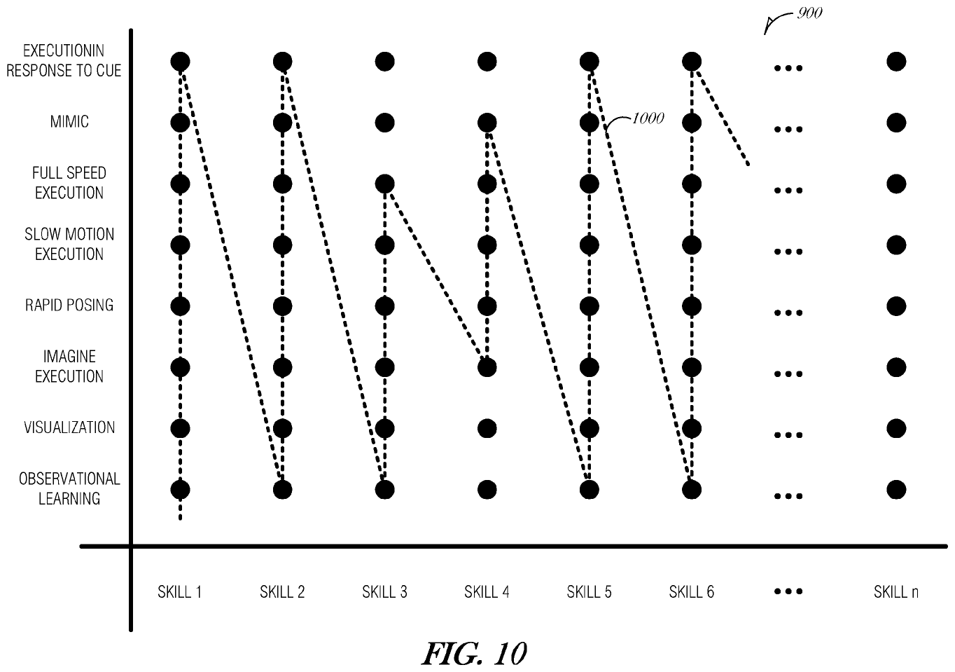

FIG. 10 is an example of the skill drill matrix 900, according to an embodiment. In the embodiment illustrated in FIG. 10, a single progression path 1000 is provided. The path 1000 may begin at any point in the skill drill matrix 900, but in FIG. 10, the path 1000 begins in the lower-left corner of the matrix, which represents the simplest skill and the most basic skill drill type—Observational Learning. As the practitioner progresses and increases in ability, the path 1000 leads them to increasingly difficult skill drill types for the particular skill. The path 1000 does not always begin at the lowest skill drill type. It may be optimal to begin training some skills at a different point. Additionally, the path 1000 does not always end at the highest skill drill type. Again, this may be due to a decreased effectiveness of certain skill drill types for certain skills.

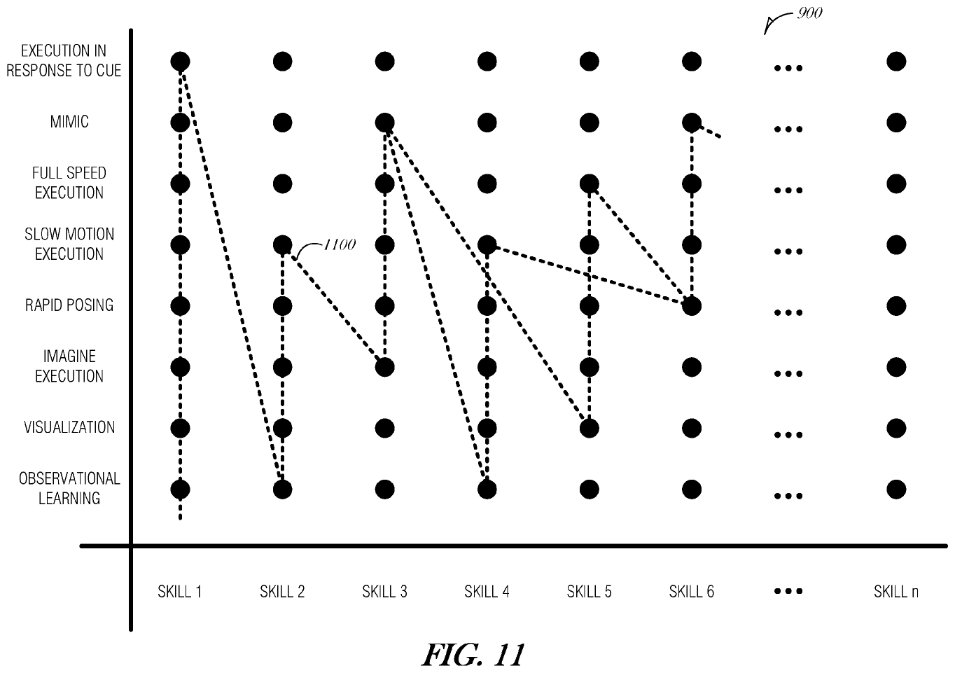

FIG. 11 is an example of the skill drill matrix 900, according to an embodiment. In FIG. 11, a skill progression path 1100 may split at a certain skill drill type for a certain skill. The split progression path 1100 represents parallel exercise routines. For example, Skills 4 and 5 may be practiced in parallel due to an interrelationship between the physical activities involved. After achieving a particular proficiency with these skills, the skill progression path 1100 may merge and the practitioner may continue advancing with one skill (e.g., Skill 6) at a time. Skill progression path 1100 may split and merge several times in a training routine.

Training System with Automated Feedback

A visual-based training system may include automated computer feedback. Automated computer feedback may include comparing an user's performance of a skill captured during local user motion capture practice to a professional's performance of the skill or a computer model version of the skill, such as an idealized performance of the skill. The comparison may be done using an overlay of the user's performance with the other performance, a side by side comparison, a sequence of videos, etc. The feedback may include progressing the user to the next level of the skill or to another skill when the user shows proficiency in the skill. In another example, feedback may include a user's attempt to match a technique in a skill, and having a coach give the user feedback verbally or otherwise. Automated computer feedback may include an error signature value computed using an algorithm that compares certain features of a user's captured motion with a model of the motion for a skill. For example, the error signature value may include a distance between a model position and a user's position at a specified time during performance of a skill. The error signature value may also include a speed difference, a timing difference, or the like, between a model position and a user's position for a specified portion of the skill. In these examples, the feedback is quantifiable, relatively or absolutely, and a user's performance may be compared to another user's performance. Feedback may include dividing a skill into various subskills and progressing a user through one or more skill drills for improving a subskill before progressing the user to the next skill.

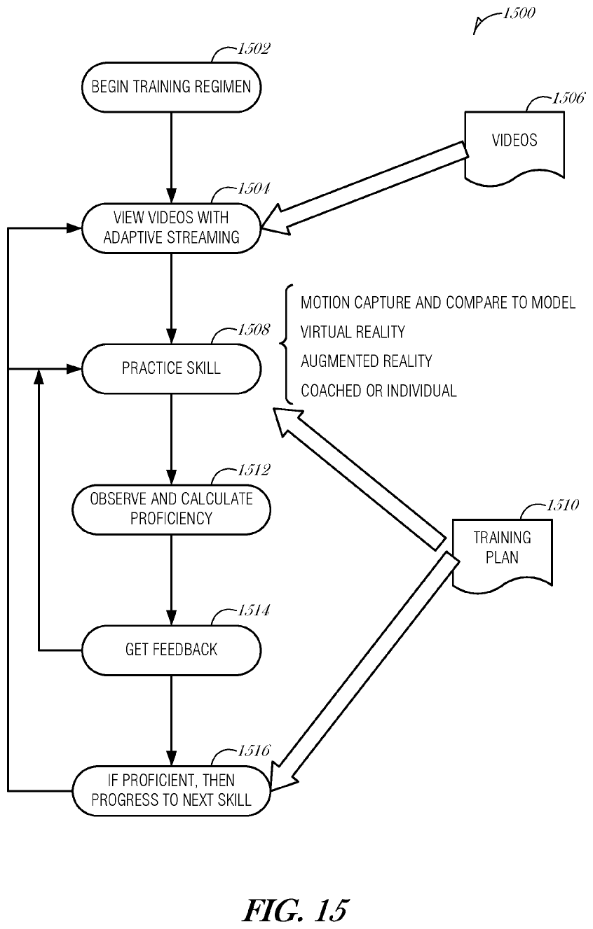

FIG. 15 is a block diagram illustrating control flow 1500 of a training system, according to an embodiment. At stage 1502, a person begins a training regimen for a skill or a set of skills. The person may start with any type of practice or exercise, but for the purposes of this example illustration, the person begins with viewing videos with adaptive streaming (stage 1504). The videos may be adaptively altered to increase the person's capability of absorbing and learning the skill (e.g., by reducing inattention). The videos 1506 may be accessed from a networked video library server, the person's own computer, or other sources. The videos may be modified on the server, at the person's computer, or elsewhere. Various possible video modifications may include altering music tracks, increasing or decreasing playback volume, adding special effects to elements on the periphery to stimulate the user's peripheral vision, changing the perspective or view of the actor performing skills in the video, using wireframe, slow motion, etc.

The person may practice the skill (stage 1508). The person may practice with the videos, independently or with a coach or trainer. The person may also use a motion capture system to capture the person's attempts at the skill, which may be played back to the person or compared to a model to assess the person's proficiency. By viewing themselves attempt the skill, the person may gain insight into their own deficiencies, with or without the assistance of a coach.

The person's practice may be guided by a training plan 1510. The training plan 1510 may include several skills and skill drill types organized into a progressive training path (e.g., as illustrated in FIG. 9). As such, the person's practice at stage 1508 may be focused on a few (or one) exercises of one skill drill type. The person may be practicing several skills in parallel with more than one skill drill type, depending on the training plan 1510.

At stage 1512, the person's attempts are observed and measured for proficiency. While a human coach may observe and evaluate a person's attempts, in embodiments described in this document, a computerized mechanism performed the observation and evaluation automatically. This may be done, at least in part, by using motion capture, error signatures, verbal/audio feedback, or some visual feedback mechanism. As such, at stage 1514, the person is provided feedback on their attempts. The feedback may be provided by a visual overlay of a model form on top of the person's motion-captured video attempt. The feedback may be numerical in part, such as by expressing a certain percentage or scale of performance (e.g., 90% correct form, or a 8/10 performance rating). Error signature values may be presented in the visual feedback. The error signature values may also be used to identify qualitative feedback for the person, such as verbal instruction on particular portion of the skill. The qualitative feedback may be chosen based on the nature of the specific error signature, such as the magnitude or the ranking of the error signature value. The person may continue practicing the skill (flow transitions back to stage 1508). If the person has attained a certain level of proficiency, then at stage 1516, the training plan 1510 is referenced and a new skill drill type or skill is identified. The person may transition to various stages in the control flow 1500, depending on the training plan 1510.

Another noteworthy idea is to consider the computerized system which measures human performance against an ideal model and uses that comparison to generate feedback and control progression may dynamically increase constraints on body position and timing. In essence this is saying that the system will have adjustable positional displacement tolerance ranges (angular displacement or linear displacement) for body positions in space such that if the user is within the tolerated range, the system will consider it a “pass”; if not it will consider it a “fail.”

The straight forward implementation of this stems from the idea that users will start worse and the system may impose less rigorous constraints for beginners before tightening up as they progress and improve. However, the important thing is that the testing constraints may be adjusted as needed for optimal learning regardless if that trend always has the testing constraints progressing from loose to tight or if it winds up being more nuanced.

Another consideration is progressing through techniques. This means that the test dynamic changes not only in terms of the rigor of the constraints, but also in terms of the complexity of the techniques that are tested.

Considering both of these dynamics (loose-to-tight constraints and simple to complex movement skills), one may envision many routes from loose constraints on simple skills to tight constraints on multi joint complex skills. It is expected that the preferred route may match that general trend, but may specifically include at least some progression from loose to tight on testing constraints within each skill before moving on to the next skill in the technique progression.

There is another dynamic in play which is how body parts are focused on with measurements. During any sample set of repetitions of a certain technique, the system may focus on the knees, the hips, the core, the left hand, the right elbow, or other physical location. There is logical progression built into how we sequence these focus options. We may sequence them, generally, within any one or a hybrid of the following three schemes: (1) starting close to the core and working toward the extremities; (2) starting with the contact point with the ground, working toward the core, and then out to the extremities that are not in contact with the ground; or (3) first working on body parts that feature movements that are important chronologically earliest in a technique and working toward ones that are important later in the technique.

In practice, these schemes are highly interrelated. For example many techniques involve the first movement happening at the feet (contact point with the ground). The forces involved in that movement would then be transferred to the core and then out to the hands. In this case, schemes 2 and 3 above would be effectively the same. This is the case in the golf swing, for example.

In other cases, one has to get body parts such as the knees into the right position before even really initiating technique movement. This is the case in the hockey skating stride. In this technique the core, hip, and knee positions are foundational and should be taught first before working out to the extremities.

One can see that within an optimized system the sequence in which body parts are focused on is highly task dependent within the progression for a single task and discipline dependent for skill sets of disciplines.

Expanding on this distinction it is important to understand how the three skill progression dynamics described here interact within a discipline. Within a given discipline there are discrete skills that may be broken down into trainable subskills. In addition, each skill may itself be a subskill. For any given discrete skill, the system may facilitate and optimize the use of loose-to-tight constraints which we use to ascertain if any measured repetition was a pass or a fail and what sort of feedback to provide. It will also facilitate and optimize the use of ordered focus adjustment which focuses the measurement on different parts of the body to ensure that things that have been determined to be foundational or prerequisite are addressed earlier than those that depend on them.

The third dynamic applies not at the level of discrete skills, but instead at the level of a building a skill set. It considers how to order the sequence of techniques that a trainee will work through. In this case the general idea is to consider all of the skills and subskills included in the progression for a discipline and develop an understanding of what skills are components of other skills. Then all skills that are components of other skills may be considered to “support” their “superskills” (read “superskill” to be the opposite of “subskill”). Then one may progress through the skill set in a manner to build up supporting skills before working on the skills that they support.

In an embodiment the discipline in question may be the sport of ice hockey. In order to define the skills that for the technique progression, an expert instructor may be consulted. This may involve the use of the subskills detection system described elsewhere in this document to identify component movement signatures within each skill, or both. In ice hockey, for example, major skill areas include skating, puckhandling, passing, and shooting. Within skating are included the skills of the forward stride, forward crossovers, power turn, heel to heel turn, backward stride, backward crossover, and various transitions between forward and backward. With each of these, skills such as deep knee bend gliding ability, good posture, and smooth acceleration during pushing leg extension are considered subskills. Through consultation with an expert instructor or subskills detection, more skill/subskill layers may be identified.

With the set of skills to teach established, a progression to teach said skills is created. In traditional methods of ice hockey skill development this progression is generally linear but features some branching and parallel paths. In ice hockey it is common for players to learn basic skating skills first before eventually developing skating, puckhandling, passing, and shooting simultaneously on these parallel paths.

Once the progression through the skill set for ice hockey is established, the system for providing feedback and progression control follows the order defined by the progression. Further, in order to make progress through the progression the user will have to meet performance standards. In other words, each discrete skill will be triggered for training when a prerequisite skill or set of prerequisite skills have been performed to a specified level of quality. The error detection system that is described elsewhere in this document is the mechanism by which this progression control is executed. For ice hockey, this may mean that single legged balance body position with a knee bend of 90 degrees with a posture angle (angle of the torso or spine relative to the vertical) of 45 degrees must be achieved to tolerances of plus or minus 3 degrees on both before moving on to working on smooth extension of the pushing leg.

However, within each discrete technique or skill, a micro progression may also be employed. This micro progression may involve sequentially focusing on different body parts within the overall body position/movement for that skill. Within the skill of a smooth extension of the pushing leg in a forward stride, we may first focus on 90 degree knee bend on the balance leg. Our second focus may be on maintaining a 45 degree torso angle relative to the vertical (while maintaining 90 degree knee bend on the balance leg, but with looser constraints than when we were just focusing on it). A third focus may be on pushing the extending leg out at a 45 degree angle from relative to the posterior of the user (while maintaining the other qualities to a certain standard). Finally, acceleration of the foot of the pushing leg which keeps the 3rd derivative of the foot position (“Jerk”, aka 1st derivative of acceleration) to within 0.2 m/s3 and −0.2 m/s3 may be trained. This minimized absolute value of the Jerk is indicative of smooth and efficiently controlled movement.

It is possible the absolutely final focus for a given technique may be one that considers the whole body and thus, the entire technique, ensuring good technique on all the areas previously focused upon.

Finally, within each micro progression through different body part foci for a discrete skill, there will be another even more “micro” progression. This progression is from loose to tight constraints for the measured metric. For the “smooth acceleration of the pushing leg” focus within the “smooth extension of the pushing leg in the forward stride” task in ice hockey, this may mean that the Jerk measurement standard starts out at between 0.4 m/s3 and −0.4 m/s3 until the user can achieve that level of mastery a sufficient number of times out of a standard sample number, say 7 out of 10 attempts. After that, the system would demand between 0.3 m/s3 and −0.3 m/s3. Finally it would reach the final goal of demanding between 0.2 m/s3 and −0.2 m/s3. After this is achieved, it may move the user on to a new body part focus within the same technique or it may move on to the next technique.

Training designs that fit within the those described here may be implemented as part of a training regime prescribed by a medical professional or other training authority. Alternatively, they could be implemented by the user themselves as a fully “elective” program.

In this same context, it is important to understand that a goal of the system is distinct from similar systems that are designed to be implemented with the help of or under a prescribed plan by a physician. In these cases it is common to assess brain activity and use it to make changes to a visual or multi-sensory stimulus in time frames on the order of 3 to 10 seconds. In contrast, the present system intends to retain consistency in the visual stimulus for the most part over those time scales to facilitate video repetitions having a cumulative effect on motor learning. Instead our modifications to the stimulus may take place around once per week at the most.

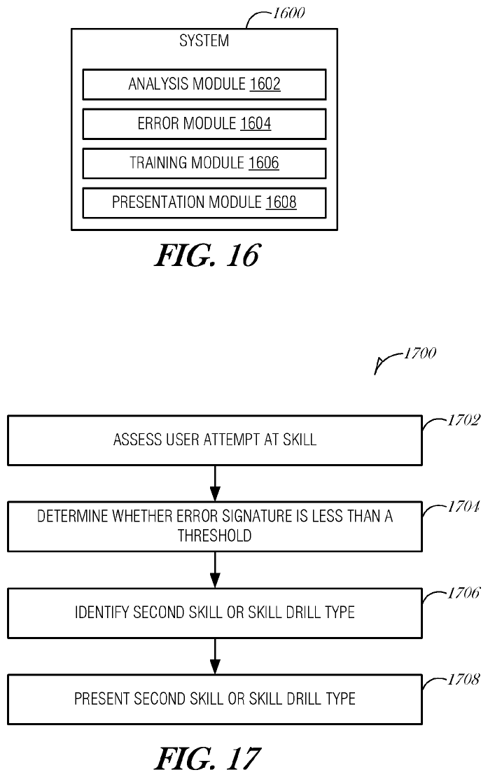

FIG. 16 is a block diagram illustrating a system 1600 for skill training, according to an embodiment. The system 1600 includes an analysis module 1602, an error module 1604, a training module 1606, and a presentation module 1608.

The analysis module 1602 may be configured to assess a motion-capture video of a user attempting a first physical skill with a first skill drill type to obtain an error signature. In an embodiment, the skill drill types are organized from a lower complexity to a higher complexity. In a further embodiment, the skill drill types include the ordered list of observational learning, visualization, and full speed execution.

The error module 1604 may be configured to determine whether all of the components of the error signature are less than a threshold. In an embodiment, to determine whether all of the components of the error signature are less than the threshold, the error module 1604 is to determine positional errors of the user attempting the first physical skill. In a further embodiment, to determine positional errors of the user attempting the first physical skill, the error module 1604 is to compare the user attempting the first physical skill to a model form of the first physical skill.

The training module 1606 may be configured to identify a second physical skill or a second skill drill type when all of the components of the error signature are less than the threshold. In an embodiment, to identify the second physical skill or the second skill drill type, the training module 1606 is to reference a training plan, the training plan organized with skill drill types and skills in a matrix according to increasing difficulty of skill drill types and increasing complexity of skills.

The presentation module 1608 may be configured to present the second physical skill or the second skill drill type to the user.

FIG. 17 is a flowchart illustrating a method 1700 of skill training, according to an embodiment. At block 1702, a motion-capture video of a user attempting a first physical skill with a first skill drill type is assessed to obtain an error signature. In an embodiment, the skill drill types are organized from a lower complexity to a higher complexity. In a further embodiment, the skill drill types include the ordered list of observational learning, visualization, and full speed execution.

At block 1704, it is determined whether all of the components of the error signature are less than a threshold. In an embodiment, determining whether all of the components of the error signature are less than the threshold comprises determining positional errors of the user attempting the first physical skill. In a further embodiment, determining positional errors of the user attempting the first physical skill comprises comparing the user attempting the first physical skill to a model form of the first physical skill.

At block 1706, a second physical skill or a second skill drill type is identified when all of the components of the error signature are less than the threshold. In an embodiment, identifying the second physical skill or the second skill drill type comprises referencing a training plan, the training plan organized with skill drill types and skills in a matrix according to increasing difficulty of skill drill types and increasing complexity of skills.

At block 1708, the second physical skill or the second skill drill type is presented to the user.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

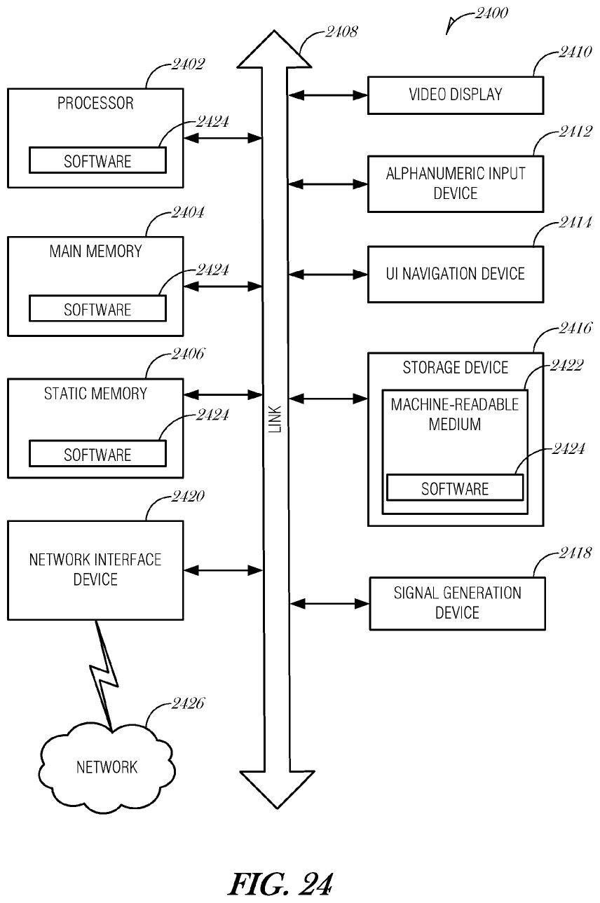

FIG. 24 is a block diagram illustrating a machine in the example form of a computer system 2400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 2400 includes at least one processor 2402 (e.g., a central processing unit (CPU), a graphics processing unit (GPU) or both, processor cores, compute nodes, etc.), a main memory 2404 and a static memory 2406, which communicate with each other via a link 2408 (e.g., bus). The computer system 2400 may further include a video display unit 2410, an alphanumeric input device 2412 (e.g., a keyboard), and a user interface (UI) navigation device 2414 (e.g., a mouse). In one embodiment, the video display unit 2410, input device 2412 and UI navigation device 2414 are incorporated into a touch screen display. The computer system 2400 may additionally include a storage device 2416 (e.g., a drive unit), a signal generation device 2418 (e.g., a speaker), a network interface device 2420, and one or more sensors (not shown), such as a global positioning system (GPS) sensor, compass, accelerometer, or other sensor.

The storage device 2416 includes a machine-readable medium 2422 on which is stored one or more sets of data structures and instructions 2424 (e.g., software) embodying or utilized by any one or more of the methodologies or functions described herein. The instructions 2424 may also reside, completely or at least partially, within the main memory 2404, static memory 2406, and/or within the processor 2402 during execution thereof by the computer system 2400, with the main memory 2404, static memory 2406, and the processor 2402 also constituting machine-readable media.

While the machine-readable medium 2422 is illustrated in an example embodiment to be a single medium, the term “machine-readable medium” may include a single medium or multiple media (e.g., a centralized or distributed database, and/or associated caches and servers) that store the one or more instructions 2424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 2424 may further be transmitted or received over a communications network 2426 using a transmission medium via the network interface device 2420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Various Notes & Examples

Additional examples of the presently described method, system, and device embodiments are suggested according to the structures and skills described herein. Other non-limiting examples can be configured to operate separately, or can be combined in any permutation or combination with any one or more of the other examples provided above or throughout the present disclosure.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### Examples

Example 1 is a system for delivering video to a viewer, the system comprising: a video selection module to select a video segment from a plurality of video segments, the plurality of video segments including content of demonstrations of a skill; a video presentation module to present the video segment multiple times to a user during a visual-based training session to train the user in the skill; and a user monitor module to determine that the user has become inattentive, wherein the video selection module is to obtain a replacement video segment in response to determining that the user has become inattentive, and wherein the video presentation module is to present the replacement video segment to the user.

In Example 2, the subject matter of Example 1 optionally includes, wherein to determine that the user has become inattentive, the user monitor module is to: access a history of viewings of the video segment; and determine that the user has become inattentive based on the number of viewings of the video segment.

In Example 3, the subject matter of Example 2 optionally includes, wherein the history of viewings comprises an identification of the video segment, a number of viewings of the video segment, and a frequency of the number of viewings in a recent timeframe.

In Example 4, the subject matter of any one or more of Examples 2-3 optionally include, wherein to determine that the user has become inattentive based on a number of viewings of the video segment, the user monitor module is to determine whether the number of viewings is less than a viewing threshold in a timeframe.

In Example 5, the subject matter of any one or more of Examples 1-4 optionally include, wherein to determine that the user has become inattentive, the user monitor module is to: obtain a biometric value of the user; compare the biometric value with a threshold value to determine whether the biometric value violates the threshold value; and determine that the user has become inattentive when the biometric value violates the threshold value.

In Example 6, the subject matter of Example 5 optionally includes, wherein the biometric value comprises at least one of: a body heat, a heart rate, or an eye activity.

In Example 7, the subject matter of any one or more of Examples 5-6 optionally include, wherein the biometric value comprises a physical activity test.

In Example 8, the subject matter of Example 7 optionally includes, wherein the physical activity test comprises finger tapping.

In Example 9, the subject matter of any one or more of Examples 1-8 optionally include, wherein to determine the user has become inattentive, the user monitor module is to: present the user a prompt; and determine that the user incorrectly reacts to the prompt.

In Example 10, the subject matter of Example 9 optionally includes, wherein to determine that the user incorrectly reacts to the prompt, the user monitor module is to determine that the user answered the prompt incorrectly.

In Example 11, the subject matter of any one or more of Examples 9-10 optionally include, wherein to determine that the user incorrectly reacts to the prompt, the user monitor module is to determine that the user failed to respond to the prompt in a threshold period of time.

In Example 12, the subject matter of any one or more of Examples 9-11 optionally include, wherein the prompt comprises a quiz related to subject matter of the video segment.

In Example 13, the subject matter of any one or more of Examples 1-12 optionally include, wherein to obtain the replacement video segment, the video selection module is to modify the video segment.

In Example 14, the subject matter of any one or more of Examples 1-13 optionally include, wherein to obtain the replacement video segment, the video selection module is to select a new video segment from the plurality of video segments.

In Example 15, the subject matter of Example 14 optionally includes, wherein to select the new video segment, the video selection module is to: access a history of viewings of the video segment; and select the new video segment based on the history.

In Example 16, the subject matter of Example 15 optionally includes, wherein the history of viewings comprises an identification of the video segment, a number of viewings of the video segment, and a frequency of the number of viewings in a recent timeframe; and wherein to select the new video segment based on the history, the video selection module is to: determine whether the number of viewings exceeds a viewing threshold; determine whether the frequency of the number of viewings in the recent timeframe exceeds a frequency threshold; and select the new video segment when the viewing threshold or the frequency threshold is violated.

In Example 17, the subject matter of Example 16 optionally includes, wherein the recent timeframe comprises a month.

In Example 18, the subject matter of Example 17 optionally includes, wherein the frequency threshold comprises one-thousand times in the month.

In Example 19, the subject matter of any one or more of Examples 16-18 optionally include, wherein the recent timeframe comprises a week.

In Example 20, the subject matter of Example 19 optionally includes, wherein the frequency threshold comprises one-hundred times in the week.

In Example 21, the subject matter of any one or more of Examples 16-20 optionally include, wherein the history of viewings further comprises a duration of the number of viewings in the recent timeframe; and wherein to select the new video segment based on the history, the video selection module is to: aggregate the number of viewings, the frequency of the number of viewings in the recent timeframe, and the duration of the number of viewings in the recent timeframe to produce an aggregate value; and select the new video segment when the aggregate value exceeds a threshold.

In Example 22, the subject matter of Example 21 optionally includes, wherein to aggregate to produce the aggregate value, the video selection module is to use a weighted function of the number of viewings, the frequency of the number of viewings in the recent timeframe, and the duration of the number of viewings in the recent timeframe.

In Example 23, the subject matter of Example 22 optionally includes, wherein the weighted function implements a minimum number of frequency of the number of viewings in the recent timeframe before including the frequency of the number of viewings in the recent timeframe in the weighted function.

In Example 24, the subject matter of any one or more of Examples 22-23 optionally include, wherein the weighted function implements a minimum number of duration of the number of viewings in the recent timeframe before including the duration of the number of viewings in the recent timeframe in the weighted function.

In Example 25, the subject matter of any one or more of Examples 21-24 optionally include, further comprising a counter module to reset the number of viewings to zero after selecting the new video segment.

In Example 26, the subject matter of any one or more of Examples 21-25 optionally include, further comprising a counter module to reset the frequency of the number of viewings to zero after selecting the new video segment.

In Example 27, the subject matter of any one or more of Examples 21-26 optionally include, further comprising a counter module to reset the duration of the number of viewings to zero after selecting the new video segment.

In Example 28, the subject matter of any one or more of Examples 14-27 optionally include, wherein to select the new video segment from the plurality of video segments, the video selection module is to: select a video segment from the plurality of video segments based on at least one of: a video style, a user preference, a time, a cultural consideration, or a cause of inattention.

In Example 29, the subject matter of any one or more of Examples 14-28 optionally include, wherein to select the new video segment from the plurality of video segments, the video selection module is to: select a video segment from the plurality of video segments based on a mathematical calculation.

In Example 30, the subject matter of any one or more of Examples 14-29 optionally include, wherein to select the new video segment from the plurality of video segments, the video selection module is to: select a video segment from the plurality of video segments based on a skill progression template.

Example 31 is a method of delivering video to a viewer, the method comprising: selecting a video segment from a plurality of video segments, the plurality of video segments including content of demonstrations of a skill; presenting the video segment multiple times to a user during a visual-based training session to train the user in the skill; determining that the user has become inattentive; obtaining a replacement video segment in response to determining that the user has become inattentive; and presenting the replacement video segment to the user.

In Example 32, the subject matter of Example 31 optionally includes, wherein determining that the user has become inattentive comprises: accessing a history of viewings of the video segment; and determining that the user has become inattentive based on the number of viewings of the video segment.

In Example 33, the subject matter of Example 32 optionally includes, wherein the history of viewings comprises an identification of the video segment, a number of viewings of the video segment, and a frequency of the number of viewings in a recent timeframe.

In Example 34, the subject matter of any one or more of Examples 32-33 optionally include, wherein determining that the user has become inattentive based on a number of viewings of the video segment comprises determining whether the number of viewings is less than a viewing threshold in a timeframe.

In Example 35, the subject matter of any one or more of Examples 31-34 optionally include, wherein determining that the user has become inattentive comprises: obtaining a biometric value of the user; comparing the biometric value with a threshold value to determine whether the biometric value violates the threshold value; and determining that the user has become inattentive when the biometric value violates the threshold value.

In Example 36, the subject matter of Example 35 optionally includes, wherein the biometric value comprises at least one of: a body heat, a heart rate, or an eye activity.

In Example 37, the subject matter of any one or more of Examples 35-36 optionally include, wherein the biometric value comprises a physical activity test.

In Example 38, the subject matter of Example 37 optionally includes, wherein the physical activity test comprises finger tapping.

In Example 39, the subject matter of any one or more of Examples 31-38 optionally include, wherein determining the user has become inattentive comprises: presenting the user a prompt; and determining that the user incorrectly reacts to the prompt.

In Example 40, the subject matter of Example 39 optionally includes, wherein determining that the user incorrectly reacts to the prompt comprises determining that the user answered the prompt incorrectly.

In Example 41, the subject matter of any one or more of Examples 39-40 optionally include, wherein determining that the user incorrectly reacts to the prompt comprises determining that the user failed to respond to the prompt in a threshold period of time.

In Example 42, the subject matter of any one or more of Examples 39-41 optionally include, wherein the prompt comprises a quiz related to subject matter of the video segment.

In Example 43, the subject matter of any one or more of Examples 31-42 optionally include, wherein obtaining the replacement video segment comprises modifying the video segment.

In Example 44, the subject matter of any one or more of Examples 31-43 optionally include, wherein obtaining the replacement video segment comprises selecting a new video segment from the plurality of video segments.

In Example 45, the subject matter of Example 44 optionally includes, wherein selecting the new video segment comprises: accessing a history of viewings of the video segment; and selecting the new video segment based on the history.

In Example 46, the subject matter of Example 45 optionally includes, wherein the history of viewings comprises an identification of the video segment, a number of viewings of the video segment, and a frequency of the number of viewings in a recent timeframe; and wherein selecting the new video segment based on the history comprises: determining whether the number of viewings exceeds a viewing threshold; determining whether the frequency of the number of viewings in the recent timeframe exceeds a frequency threshold; and selecting the new video segment when the viewing threshold or the frequency threshold is violated.

In Example 47, the subject matter of Example 46 optionally includes, wherein the recent timeframe comprises a month.

In Example 48, the subject matter of Example 47 optionally includes, wherein the frequency threshold comprises one-thousand times in the month.

In Example 49, the subject matter of any one or more of Examples 46-48 optionally include, wherein the recent timeframe comprises a week.

In Example 50, the subject matter of Example 49 optionally includes, wherein the frequency threshold comprises one-hundred times in the week.

In Example 51, the subject matter of any one or more of Examples 46-50 optionally include, wherein the history of viewings further comprises a duration of the number of viewings in the recent timeframe; and wherein selecting the new video segment based on the history comprises: aggregating the number of viewings, the frequency of the number of viewings in the recent timeframe, and the duration of the number of viewings in the recent timeframe to produce an aggregate value; and selecting the new video segment when the aggregate value exceeds a threshold.

In Example 52, the subject matter of Example 51 optionally includes, wherein aggregating to produce the aggregate value comprises using a weighted function of the number of viewings, the frequency of the number of viewings in the recent timeframe, and the duration of the number of viewings in the recent timeframe.

In Example 53, the subject matter of Example 52 optionally includes, wherein the weighted function implements a minimum number of frequency of the number of viewings in the recent timeframe before including the frequency of the number of viewings in the recent timeframe in the weighted function.

In Example 54, the subject matter of any one or more of Examples 52-53 optionally include, wherein the weighted function implements a minimum number of duration of the number of viewings in the recent timeframe before including the duration of the number of viewings in the recent timeframe in the weighted function.

In Example 55, the subject matter of any one or more of Examples 51-54 optionally include, further comprising resetting the number of viewings to zero after selecting the new video segment.

In Example 56, the subject matter of any one or more of Examples 51-55 optionally include, further comprising resetting the frequency of the number of viewings to zero after selecting the new video segment.

In Example 57, the subject matter of any one or more of Examples 51-56 optionally include, further comprising resetting the duration of the number of viewings to zero after selecting the new video segment.

In Example 58, the subject matter of any one or more of Examples 44-57 optionally include, wherein selecting the new video segment from the plurality of video segments comprises: selecting a video segment from the plurality of video segments based on at least one of: a video style, a user preference, a time, a cultural consideration, or a cause of inattention.

In Example 59, the subject matter of any one or more of Examples 44-58 optionally include, wherein selecting the new video segment from the plurality of video segments comprises: selecting a video segment from the plurality of video segments based on a mathematical calculation.

In Example 60, the subject matter of any one or more of Examples 44-59 optionally include, wherein selecting the new video segment from the plurality of video segments comprises: selecting a video segment from the plurality of video segments based on a skill progression template.

Example 61 is a computer-readable medium including instructions for delivering video to a viewer, which when executed be a computer, cause the computer to perform the method of: selecting a video segment from a plurality of video segments, the plurality of video segments including content of demonstrations of a skill; presenting the video segment multiple times to a user during a visual-based training session to train the user in the skill; determining that the user has become inattentive; obtaining a replacement video segment in response to determining that the user has become inattentive; and presenting the replacement video segment to the user.

In Example 62, the subject matter of Example 61 optionally includes, wherein determining that the user has become inattentive comprises: accessing a history of viewings of the video segment; and determining that the user has become inattentive based on the number of viewings of the video segment.

In Example 63, the subject matter of Example 62 optionally includes, wherein the history of viewings comprises an identification of the video segment, a number of viewings of the video segment, and a frequency of the number of viewings in a recent timeframe.

In Example 64, the subject matter of any one or more of Examples 62-63 optionally include, wherein determining that the user has become inattentive based on a number of viewings of the video segment comprises determining whether the number of viewings is less than a viewing threshold in a timeframe.

In Example 65, the subject matter of any one or more of Examples 61-64 optionally include, wherein determining that the user has become inattentive comprises: obtaining a biometric value of the user; comparing the biometric value with a threshold value to determine whether the biometric value violates the threshold value; and determining that the user has become inattentive when the biometric value violates the threshold value.

In Example 66, the subject matter of Example 65 optionally includes, wherein the biometric value comprises at least one of: a body heat, a heart rate, or an eye activity.

In Example 67, the subject matter of any one or more of Examples 65-66 optionally include, wherein the biometric value comprises a physical activity test.

In Example 68, the subject matter of Example 67 optionally includes, wherein the physical activity test comprises finger tapping.

In Example 69, the subject matter of any one or more of Examples 61-68 optionally include, wherein determining the user has become inattentive comprises: presenting the user a prompt; and determining that the user incorrectly reacts to the prompt.

In Example 70, the subject matter of Example 69 optionally includes, wherein determining that the user incorrectly reacts to the prompt comprises determining that the user answered the prompt incorrectly.

In Example 71, the subject matter of any one or more of Examples 69-70 optionally include, wherein determining that the user incorrectly reacts to the prompt comprises determining that the user failed to respond to the prompt in a threshold period of time.

In Example 72, the subject matter of any one or more of Examples 69-71 optionally include, wherein the prompt comprises a quiz related to subject matter of the video segment.

In Example 73, the subject matter of any one or more of Examples 61-72 optionally include, wherein obtaining the replacement video segment comprises modifying the video segment.

In Example 74, the subject matter of any one or more of Examples 61-73 optionally include, wherein obtaining the replacement video segment comprises selecting a new video segment from the plurality of video segments.

In Example 75, the subject matter of Example 74 optionally includes, wherein selecting the new video segment comprises: accessing a history of viewings of the video segment; and selecting the new video segment based on the history.

In Example 76, the subject matter of Example 75 optionally includes, wherein the history of viewings comprises an identification of the video segment, a number of viewings of the video segment, and a frequency of the number of viewings in a recent timeframe; and wherein selecting the new video segment based on the history comprises: determining whether the number of viewings exceeds a viewing threshold; determining whether the frequency of the number of viewings in the recent timeframe exceeds a frequency threshold; and selecting the new video segment when the viewing threshold or the frequency threshold is violated.

In Example 77, the subject matter of Example 76 optionally includes, wherein the recent timeframe comprises a month.

In Example 78, the subject matter of Example 77 optionally includes, wherein the frequency threshold comprises one-thousand times in the month.

In Example 79, the subject matter of any one or more of Examples 76-78 optionally include, wherein the recent timeframe comprises a week.

In Example 80, the subject matter of Example 79 optionally includes, wherein the frequency threshold comprises one-hundred times in the week.

In Example 81, the subject matter of any one or more of Examples 76-80 optionally include, wherein the history of viewings further comprises a duration of the number of viewings in the recent timeframe; and wherein selecting the new video segment based on the history comprises: aggregating the number of viewings, the frequency of the number of viewings in the recent timeframe, and the duration of the number of viewings in the recent timeframe to produce an aggregate value; and selecting the new video segment when the aggregate value exceeds a threshold.

In Example 82, the subject matter of Example 81 optionally includes, wherein aggregating to produce the aggregate value comprises using a weighted function of the number of viewings, the frequency of the number of viewings in the recent timeframe, and the duration of the number of viewings in the recent timeframe.

In Example 83, the subject matter of Example 82 optionally includes, wherein the weighted function implements a minimum number of frequency of the number of viewings in the recent timeframe before including the frequency of the number of viewings in the recent timeframe in the weighted function.

In Example 84, the subject matter of any one or more of Examples 82-83 optionally include, wherein the weighted function implements a minimum number of duration of the number of viewings in the recent timeframe before including the duration of the number of viewings in the recent timeframe in the weighted function.

In Example 85, the subject matter of any one or more of Examples 81-84 optionally include, further comprising resetting the number of viewings to zero after selecting the new video segment.

In Example 86, the subject matter of any one or more of Examples 81-85 optionally include, further comprising resetting the frequency of the number of viewings to zero after selecting the new video segment.

In Example 87, the subject matter of any one or more of Examples 81-86 optionally include, further comprising resetting the duration of the number of viewings to zero after selecting the new video segment.

In Example 88, the subject matter of any one or more of Examples 74-87 optionally include, wherein selecting the new video segment from the plurality of video segments comprises: selecting a video segment from the plurality of video segments based on at least one of: a video style, a user preference, a time, a cultural consideration, or a cause of inattention.

In Example 89, the subject matter of any one or more of Examples 74-88 optionally include, wherein selecting the new video segment from the plurality of video segments comprises: selecting a video segment from the plurality of video segments based on a mathematical calculation.

In Example 90, the subject matter of any one or more of Examples 74-89 optionally include, wherein selecting the new video segment from the plurality of video segments comprises: selecting a video segment from the plurality of video segments based on a skill progression template.

Example 91 is a system for error detection and prioritization, the system comprising: a database module to access an error detection database to obtain a set of error detection parameters, each error detection parameter describing a position of a person during execution of a physical skill, the execution having an execution timeframe; and a comparison module to compare an instance of the person during execution of the physical skill against a model form to measure positional errors of the instance of the person during execution of the physical skill with respect to the model form.

In Example 92, the subject matter of Example 91 optionally includes, wherein each of the error detection parameters are respectively associated with a time range in the execution timeframe of the physical skill.

In Example 93, the subject matter of Example 92 optionally includes, wherein measuring positional errors of the instance of the person with respect to the model form for a particular error detection parameter is performed in the time range associated with the particular error detection parameter.

In Example 94, the subject matter of any one or more of Examples 91-93 optionally include, wherein the position of the person during execution of the physical skill comprises a joint position or a limb position.

In Example 95, the subject matter of any one or more of Examples 91-94 optionally include, wherein the error detection parameters correspond to joint positions, limb positions, or body positions during the execution of the physical skill.

In Example 96, the subject matter of any one or more of Examples 91-95 optionally include, wherein the model form represents an ideal execution of the physical skill.

In Example 97, the subject matter of any one or more of Examples 91-96 optionally include, wherein the system is to: sort positional errors of the instance of the person with the model form.

In Example 98, the subject matter of Example 97 optionally includes, wherein the system is to: identify the largest positional error based on the sorted positional errors; and notify a user of the largest positional error.

In Example 99, the subject matter of Example 98 optionally includes, wherein the system is to: obtain a training routine from a skills database based on the largest positional error; and present the training routine to the user.

In Example 100, the subject matter of any one or more of Examples 91-99 optionally include, wherein the system is to: determine that positional errors of the instance of the person with the model form are each less than a threshold; and notify a user that the instance of the person during execution of the physical skill was a successful performance.

Example 101 is a method of error detection and prioritization, the method comprising: accessing an error detection database to obtain a set of error detection parameters, each error detection parameter describing a position of a person during execution of a physical skill, the execution having an execution timeframe; and comparing an instance of the person during execution of the physical skill against a model form to measure positional errors of the instance of the person during execution of the physical skill with respect to the model form.

In Example 102, the subject matter of Example 101 optionally includes, wherein each of the error detection parameters are respectively associated with a time range in the execution timeframe of the physical skill.

In Example 103, the subject matter of Example 102 optionally includes, wherein measuring positional errors of the instance of the person with respect to the model form for a particular error detection parameter is performed in the time range associated with the particular error detection parameter.

In Example 104, the subject matter of any one or more of Examples 101-103 optionally include, wherein the position of the person during execution of the physical skill comprises a joint position or a limb position.

In Example 105, the subject matter of any one or more of Examples 101-104 optionally include, wherein the error detection parameters correspond to joint positions, limb positions, or body positions during the execution of the physical skill.

In Example 106, the subject matter of any one or more of Examples 101-105 optionally include, wherein the model form represents an ideal execution of the physical skill.

In Example 107, the subject matter of any one or more of Examples 101-106 optionally include, further comprising: sorting positional errors of the instance of the person with the model form.

In Example 108, the subject matter of Example 107 optionally includes, further comprising: identifying the largest positional error based on the sorted positional errors; and notifying a user of the largest positional error.

In Example 109, the subject matter of Example 108 optionally includes, further comprising: obtaining a training routine from a skills database based on the largest positional error; and presenting the training routine to the user.

In Example 110, the subject matter of any one or more of Examples 101-109 optionally include, further comprising: determining that positional errors of the instance of the person with the model form are each less than a threshold; and notifying a user that the instance of the person during execution of the physical skill was a successful performance.

Example 111 is a computer-readable medium including instructions for error detection and prioritization, which when executed be a computer, cause the computer to perform the method of: accessing an error detection database to obtain a set of error detection parameters, each error detection parameter describing a position of a person during execution of a physical skill, the execution having an execution timeframe; and comparing an instance of the person during execution of the physical skill against a model form to measure positional errors of the instance of the person during execution of the physical skill with respect to the model form.

In Example 112, the subject matter of Example 111 optionally includes, wherein each of the error detection parameters are respectively associated with a time range in the execution timeframe of the physical skill.

In Example 113, the subject matter of Example 112 optionally includes, wherein measuring positional errors of the instance of the person with respect to the model form for a particular error detection parameter is performed in the time range associated with the particular error detection parameter.

In Example 114, the subject matter of any one or more of Examples 111-113 optionally include, wherein the position of the person during execution of the physical skill comprises a joint position or a limb position.

In Example 115, the subject matter of any one or more of Examples 111-114 optionally include, wherein the error detection parameters correspond to joint positions, limb positions, or body positions during the execution of the physical skill.

In Example 116, the subject matter of any one or more of Examples 111-115 optionally include, wherein the model form represents an ideal execution of the physical skill.

In Example 117, the subject matter of any one or more of Examples 111-116 optionally include, further comprising: sorting positional errors of the instance of the person with the model form.

In Example 118, the subject matter of Example 117 optionally includes, further comprising: identifying the largest positional error based on the sorted positional errors; and notifying a user of the largest positional error.

In Example 119, the subject matter of Example 118 optionally includes, further comprising: obtaining a training routine from a skills database based on the largest positional error; and presenting the training routine to the user.

In Example 120, the subject matter of any one or more of Examples 111-119 optionally include, further comprising: determining that positional errors of the instance of the person with the model form are each less than a threshold; and notifying a user that the instance of the person during execution of the physical skill was a successful performance.

Example 121 is a system for skill training, the system comprising: an analysis module to assess a motion-capture video of a user attempting a first physical skill with a first skill drill type to obtain an error signature; an error module to determine whether all of the components of the error signature are less than a threshold; a training module to identify a second physical skill or a second skill drill type when all of the components of the error signature are less than the threshold; and a presentation module to present the second physical skill or the second skill drill type to the user.

In Example 122, the subject matter of Example 121 optionally includes, wherein the skill drill types are organized from a lower complexity to a higher complexity.

In Example 123, the subject matter of Example 122 optionally includes, wherein the skill drill types include the ordered list of observational learning, visualization, and full speed execution.

In Example 124, the subject matter of any one or more of Examples 121-123 optionally include, wherein to determine whether all of the components of the error signature are less than the threshold, the error module is to: determine positional errors of the user attempting the first physical skill.

In Example 125, the subject matter of Example 124 optionally includes, wherein to determine positional errors of the user attempting the first physical skill, the error module is to: compare the user attempting the first physical skill to a model form of the first physical skill.

In Example 126, the subject matter of any one or more of Examples 121-125 optionally include, wherein to identify the second physical skill or the second skill drill type, the training module is to: reference a training plan, the training plan organized with skill drill types and skills in a matrix according to increasing difficulty of skill drill types and increasing complexity of skills.

Example 127 is a method of skill training, the method comprising: assessing a motion-capture video of a user attempting a first physical skill with a first skill drill type to obtain an error signature; determining whether all of the components of the error signature are less than a threshold; identifying a second physical skill or a second skill drill type when all of the components of the error signature are less than the threshold; and presenting the second physical skill or the second skill drill type to the user.

In Example 128, the subject matter of Example 127 optionally includes, wherein the skill drill types are organized from a lower complexity to a higher complexity.

In Example 129, the subject matter of Example 128 optionally includes, wherein the skill drill types include the ordered list of observational learning, visualization, and full speed execution.

In Example 130, the subject matter of any one or more of Examples 127-129 optionally include, wherein determining whether all of the components of the error signature are less than the threshold comprises: determining positional errors of the user attempting the first physical skill.

In Example 131, the subject matter of Example 130 optionally includes, wherein determining positional errors of the user attempting the first physical skill comprises: comparing the user attempting the first physical skill to a model form of the first physical skill.

In Example 132, the subject matter of any one or more of Examples 127-131 optionally include, wherein identifying the second physical skill or the second skill drill type comprises: referencing a training plan, the training plan organized with skill drill types and skills in a matrix according to increasing difficulty of skill drill types and increasing complexity of skills.

Example 133 is a computer-readable medium including instructions for skill training, which when executed be a computer, cause the computer to perform the method of: assessing a motion-capture video of a user attempting a first physical skill with a first skill drill type to obtain an error signature; determining whether all of the components of the error signature are less than a threshold; identifying a second physical skill or a second skill drill type when all of the components of the error signature are less than the threshold; and presenting the second physical skill or the second skill drill type to the user.

In Example 134, the subject matter of Example 133 optionally includes, wherein the skill drill types are organized from a lower complexity to a higher complexity.

In Example 135, the subject matter of Example 134 optionally includes, wherein the skill drill types include the ordered list of observational learning, visualization, and full speed execution.

In Example 136, the subject matter of any one or more of Examples 133-135 optionally include, wherein determining whether all of the components of the error signature are less than the threshold comprises: determining positional errors of the user attempting the first physical skill.

In Example 137, the subject matter of Example 136 optionally includes, wherein determining positional errors of the user attempting the first physical skill comprises: comparing the user attempting the first physical skill to a model form of the first physical skill.

In Example 138, the subject matter of any one or more of Examples 133-137 optionally include, wherein identifying the second physical skill or the second skill drill type comprises: referencing a training plan, the training plan organized with skill drill types and skills in a matrix according to increasing difficulty of skill drill types and increasing complexity of skills.

Example 139 is a system for visual-based training, the system comprising: a presentation module to: present a dark environment to a user in a virtual reality environment, the user equipped with a virtual reality headset; and present a lighted scene to the user, the lighted scene including an object for the user to visually track; and a user tracking module to track the user's actions while the user visually tracks the object, wherein the presentation module is to provide feedback to the user based on the user's actions.

In Example 140, the subject matter of Example 139 optionally includes, wherein the dark environment comprises a projected dark field.

In Example 141, the subject matter of Example 140 optionally includes, wherein the projected dark field is presented on translucent eyeglasses worn by the user.

In Example 142, the subject matter of any one or more of Examples 139-141 optionally include, wherein the object is a baseball.

In Example 143, the subject matter of Example 142 optionally includes, wherein the lighted scene comprises a baseball pitch, and wherein to track the user's actions, the user tracking module is to track a virtual bat being held by the user.

In Example 144, the subject matter of any one or more of Examples 142-143 optionally include, wherein the lighted scene comprises a baseball pitch, and wherein to track the user's actions, the user tracking module is to track head movement during the baseball pitch.

In Example 145, the subject matter of Example 144 optionally includes, wherein to provide feedback, the presentation module is to: present the user's body position at a point in time during the baseball pitch.

In Example 146, the subject matter of Example 145 optionally includes, wherein to present the user's body position, the presentation module is to present a head position of the user at a point of contact.

In Example 147, the subject matter of any one or more of Examples 145-146 optionally include, wherein to present the user's body position, the presentation module is to present a head position of the user at points in time during the approach of a baseball during the baseball pitch.

In Example 148, the subject matter of any one or more of Examples 142-147 optionally include, wherein the lighted scene comprises a baseball pitch, and wherein to track the user's actions, the user tracking module is to track a physical bat being held by the user.

In Example 149, the subject matter of any one or more of Examples 139-148 optionally include, wherein the object is a tennis ball.

In Example 150, the subject matter of Example 149 optionally includes, wherein the lighted scene comprises a tennis serve, and wherein to track the user's actions, the user tracking module is to track a virtual racquet being held by the user.

In Example 151, the subject matter of any one or more of Examples 149-150 optionally include, wherein the lighted scene comprises a tennis serve, and wherein to track the user's actions, the user tracking module is to track head movement during the tennis serve.

In Example 152, the subject matter of any one or more of Examples 149-151 optionally include, wherein the lighted scene comprises a tennis serve, and wherein to track the user's actions, the user tracking module is to track a physical racquet being held by the user.

In Example 153, the subject matter of Example 152 optionally includes, wherein to provide feedback, the presentation module is to: present the user's body position at a point in time during the tennis serve.

In Example 154, the subject matter of Example 153 optionally includes, wherein to present the user's body position, the presentation module is to present a head position of the user at a point of contact.

In Example 155, the subject matter of any one or more of Examples 153-154 optionally include, wherein to present the user's body position, the presentation module is to present a head position of the user at points in time during the approach of a tennis ball during the tennis serve.

In Example 156, the subject matter of any one or more of Examples 139-155 optionally include, wherein the lighted scene comprises a martial arts situation, and wherein to track the user's actions, the user tracking module is to track a martial arts action by the user.

In Example 157, the subject matter of Example 156 optionally includes, wherein the martial arts action comprises a block or a dodge.

In Example 158, the subject matter of any one or more of Examples 139-157 optionally include, wherein the lighted scene comprises a martial arts situation, and wherein to track the user's actions, the user tracking module is to track head movement during martial arts situation.

In Example 159, the subject matter of any one or more of Examples 139-158 optionally include, wherein to provide feedback, the presentation module is to: present the user's body position at a point in time while the user is visually tracking the object.

In Example 160, the subject matter of Example 159 optionally includes, wherein to present the user's body position, the presentation module is to present a head position of the user at a point of contact with the object.

Example 161 is a method of visual-based training, the method comprising: presenting a dark environment to a user in a virtual reality environment, the user equipped with a virtual reality headset; presenting a lighted scene to the user, the lighted scene including an object for the user to visually track; tracking the user's actions while the user visually tracks the object; and providing feedback to the user based on the user's actions.

In Example 162, the subject matter of Example 161 optionally includes, wherein the dark environment comprises a projected dark field.

In Example 163, the subject matter of Example 162 optionally includes, wherein the projected dark field is presented on translucent eyeglasses worn by the user.

In Example 164, the subject matter of any one or more of Examples 161-163 optionally include, wherein the object is a baseball.

In Example 165, the subject matter of Example 164 optionally includes, wherein the lighted scene comprises a baseball pitch, and wherein tracking the user's actions comprises: tracking a virtual bat being held by the user.

In Example 166, the subject matter of any one or more of Examples 164-165 optionally include, wherein the lighted scene comprises a baseball pitch, and wherein tracking the user's actions comprises: tracking head movement during the baseball pitch.

In Example 167, the subject matter of Example 166 optionally includes, wherein providing feedback comprises: presenting the user's body position at a point in time during the baseball pitch.

In Example 168, the subject matter of Example 167 optionally includes, wherein presenting the user's body position comprises presenting a head position of the user at the point of contact.

In Example 169, the subject matter of any one or more of Examples 167-168 optionally include, wherein presenting the user's body position comprises presenting a head position of the user at points in time during the approach of a baseball during the baseball pitch.

In Example 170, the subject matter of any one or more of Examples 164-169 optionally include, wherein the lighted scene comprises a baseball pitch, and wherein tracking the user's actions comprises: tracking a physical bat being held by the user.

In Example 171, the subject matter of any one or more of Examples 161-170 optionally include, wherein the object is a tennis ball.

In Example 172, the subject matter of Example 171 optionally includes, wherein the lighted scene comprises a tennis serve, and wherein tracking the user's actions comprises: tracking a virtual racquet being held by the user.

In Example 173, the subject matter of any one or more of Examples 171-172 optionally include, wherein the lighted scene comprises a tennis serve, and wherein tracking the user's actions comprises: tracking head movement during the tennis serve.

In Example 174, the subject matter of any one or more of Examples 171-173 optionally include, wherein the lighted scene comprises a tennis serve, and wherein tracking the user's actions comprises: tracking a physical racquet being held by the user.

In Example 175, the subject matter of Example 174 optionally includes, further comprising: presenting the user's body position at a point in time during the tennis serve.

In Example 176, the subject matter of Example 175 optionally includes, presenting the user's body position comprises presenting a head position of the user at the point of contact.

In Example 177, the subject matter of any one or more of Examples 175-176 optionally include, presenting the user's body position comprises presenting a head position of the user at points in time during the approach of a tennis ball during the tennis serve.

In Example 178, the subject matter of any one or more of Examples 161-177 optionally include, wherein the lighted scene comprises a martial arts situation, and wherein tracking the user's actions comprises: tracking a martial arts action by the user.

In Example 179, the subject matter of Example 178 optionally includes, wherein the martial arts action comprises a block or a dodge.

In Example 180, the subject matter of any one or more of Examples 161-179 optionally include, wherein the lighted scene comprises a martial arts situation, and wherein tracking the user's actions comprises: tracking head movement during martial arts situation.

In Example 181, the subject matter of any one or more of Examples 161-180 optionally include, wherein providing feedback comprises: presenting the user's body position at a point in time while the user is visually tracking the object.

In Example 182, the subject matter of Example 181 optionally includes, wherein presenting the user's body position comprises presenting a head position of the user at a point of contact with the object.

Example 183 is a computer-readable medium including instructions for visual-based training, which when executed be a computer, cause the computer to perform the method of: presenting a dark environment to a user in a virtual reality environment, the user equipped with a virtual reality headset; presenting a lighted scene to the user, the lighted scene including an object for the user to visually track; tracking the user's actions while the user visually tracks the object; and providing feedback to the user based on the user's actions.

In Example 184, the subject matter of Example 183 optionally includes, wherein the dark environment comprises a projected dark field.

In Example 185, the subject matter of Example 184 optionally includes, wherein the projected dark field is presented on translucent eyeglasses worn by the user.

In Example 186, the subject matter of any one or more of Examples 183-185 optionally include, wherein the object is a baseball.

In Example 187, the subject matter of Example 186 optionally includes, wherein the lighted scene comprises a baseball pitch, and wherein tracking the user's actions comprises: tracking a virtual bat being held by the user.

In Example 188, the subject matter of any one or more of Examples 186-187 optionally include, wherein the lighted scene comprises a baseball pitch, and wherein tracking the user's actions comprises: tracking head movement during the baseball pitch.

In Example 189, the subject matter of Example 188 optionally includes, wherein providing feedback comprises: presenting the user's body position at a point in time during the baseball pitch.

In Example 190, the subject matter of Example 189 optionally includes, wherein presenting the user's body position comprises presenting a head position of the user at the point of contact.

In Example 191, the subject matter of any one or more of Examples 189-190 optionally include, wherein presenting the user's body position comprises presenting a head position of the user at points in time during the approach of a baseball during the baseball pitch.

In Example 192, the subject matter of any one or more of Examples 186-191 optionally include, wherein the lighted scene comprises a baseball pitch, and wherein tracking the user's actions comprises: tracking a physical bat being held by the user.

In Example 193, the subject matter of any one or more of Examples 183-192 optionally include, wherein the object is a tennis ball.

In Example 194, the subject matter of Example 193 optionally includes, wherein the lighted scene comprises a tennis serve, and wherein tracking the user's actions comprises: tracking a virtual racquet being held by the user.

In Example 195, the subject matter of any one or more of Examples 193-194 optionally include, wherein the lighted scene comprises a tennis serve, and wherein tracking the user's actions comprises: tracking head movement during the tennis serve.

In Example 196, the subject matter of any one or more of Examples 193-195 optionally include, wherein the lighted scene comprises a tennis serve, and wherein tracking the user's actions comprises: tracking a physical racquet being held by the user.

In Example 197, the subject matter of Example 196 optionally includes, further comprising: presenting the user's body position at a point in time during the tennis serve.

In Example 198, the subject matter of Example 197 optionally includes, presenting the user's body position comprises presenting a head position of the user at the point of contact.

In Example 199, the subject matter of any one or more of Examples 197-198 optionally include, presenting the user's body position comprises presenting a head position of the user at points in time during the approach of a tennis ball during the tennis serve.

In Example 200, the subject matter of any one or more of Examples 183-199 optionally include, wherein the lighted scene comprises a martial arts situation, and wherein tracking the user's actions comprises: tracking a martial arts action by the user.

In Example 201, the subject matter of Example 200 optionally includes, wherein the martial arts action comprises a block or a dodge.

In Example 202, the subject matter of any one or more of Examples 183-201 optionally include, wherein the lighted scene comprises a martial arts situation, and wherein tracking the user's actions comprises: tracking head movement during martial arts situation.

In Example 203, the subject matter of any one or more of Examples 183-202 optionally include, wherein providing feedback comprises: presenting the user's body position at a point in time while the user is visually tracking the object.

In Example 204, the subject matter of Example 203 optionally includes, wherein presenting the user's body position comprises presenting a head position of the user at a point of contact with the object.

Example 205 is a system for visual-based training, the system comprising: a presentation module to: present an environment to a user in a virtual reality environment; and present a scene to the user in the environment, the scene including an object for the user to visually track; and a user tracking module to track the user's head movement while the user visually tracks the object, wherein the presentation module is to provide feedback to the user based on the user's head movement.

In Example 206, the subject matter of Example 205 optionally includes, wherein the object is a baseball, and wherein the scene includes a baseball pitch, and wherein the user tracking module is to track the user's head movement while the user tracks the baseball during the baseball pitch.

Example 207 is a method of visual-based training, the method comprising: presenting an environment to a user in a virtual reality environment; presenting a scene to the user in the environment, the scene including an object for the user to visually track; tracking the user's head movement while the user visually tracks the object; and providing feedback to the user based on the user's head movement.

In Example 208, the subject matter of Example 207 optionally includes, wherein the object is a baseball, and wherein the scene includes a baseball pitch, and wherein tracking the user's head movement is performed while the user tracks the baseball during the baseball pitch.

Example 209 is a computer-readable medium including instructions for visual-based training, which when executed be a computer, cause the computer to perform the method of: presenting an environment to a user in a virtual reality environment; presenting a scene to the user in the environment, the scene including an object for the user to visually track; tracking the user's head movement while the user visually tracks the object; and providing feedback to the user based on the user's head movement.

In Example 210, the subject matter of Example 209 optionally includes, wherein the object is a baseball, and wherein the scene includes a baseball pitch, and wherein tracking the user's head movement is performed while the user tracks the baseball during the baseball pitch.

Example 211 is a system for visual-based training, the system comprising: a presentation module to: present an environment to a user in a virtual reality environment; and present a scene to the user in the environment, the scene including an object for the user to visually track; and a user tracking module to track the user's eye movement while the user visually tracks the object, wherein the presentation module is to provide feedback to the user based on the user's eye movement.

In Example 212, the subject matter of Example 211 optionally includes, wherein the object is a baseball, and wherein the scene includes a baseball pitch, and wherein the user tracking module is to track the user's eye movement while the user tracks the baseball during the baseball pitch.

Example 213 is a method of visual-based training, the method comprising: presenting an environment to a user in a virtual reality environment; presenting a scene to the user in the environment, the scene including an object for the user to visually track; tracking the user's eye movement while the user visually tracks the object; and providing feedback to the user based on the user's eye movement.

In Example 214, the subject matter of Example 213 optionally includes, wherein the object is a baseball, and wherein the scene includes a baseball pitch, and wherein tracking the user's eye movement is performed while the user tracks the baseball during the baseball pitch.

Example 215 is a computer-readable medium including instructions for visual-based training, which when executed be a computer, cause the computer to perform the method of: presenting an environment to a user in a virtual reality environment; presenting a scene to the user in the environment, the scene including an object for the user to visually track; tracking the user's eye movement while the user visually tracks the object; and providing feedback to the user based on the user's eye movement.

In Example 216, the subject matter of Example 215 optionally includes, wherein the object is a baseball, and wherein the scene includes a baseball pitch, and wherein tracking the user's eye movement is performed while the user tracks the baseball during the baseball pitch.

Example 217 is a system for visual-based training, the system comprising: a presentation module to: present an environment to a user in a virtual reality environment; and present a scene to the user in the environment, the scene including an object for the user to visually track; and a user tracking module to track a user's movement while the user visually tracks the object, wherein the presentation module is to provide feedback to the user based on the user's movement.

In Example 218, the subject matter of Example 217 optionally includes, wherein the object is a baseball, wherein the scene includes a baseball pitch, wherein the user tracking module is to track the user's attempt to hit the baseball during the baseball pitch, and wherein the presentation module is to provide timing information regarding the user's attempt to hit the baseball.

In Example 219, the subject matter of Example 218 optionally includes, wherein the timing information includes a visual or audio cue indicating a time to begin the attempt to hit the baseball.

In Example 220, the subject matter of any one or more of Examples 218-219 optionally include, wherein the timing information includes information of the user's performance compared to a model performance.

Example 221 is a method of visual-based training, the method comprising: presenting an environment to a user in a virtual reality environment; presenting a scene to the user in the environment, the scene including an object for the user to visually track; tracking the user's head movement while the user visually tracks the object; and providing feedback to the user based on the user's head movement.

In Example 222, the subject matter of Example 221 optionally includes, wherein the object is a baseball, and wherein the scene includes a baseball pitch, and wherein tracking the user's movement includes tracking the user's attempt to hit the baseball during the baseball pitch, and wherein providing feedback includes providing timing information regarding the user's attempt to hit the baseball.

In Example 223, the subject matter of Example 222 optionally includes, wherein the timing information includes a visual or audio cue indicating a time to begin the attempt to hit the baseball.

In Example 224, the subject matter of any one or more of Examples 222-223 optionally include, wherein the timing information includes information of the user's performance compared to a model performance.

Example 225 is a computer-readable medium including instructions for visual-based training, which when executed be a computer, cause the computer to perform the method of: presenting an environment to a user in a virtual reality environment; presenting a scene to the user in the environment, the scene including an object for the user to visually track; tracking the user's head movement while the user visually tracks the object; and providing feedback to the user based on the user's head movement.

In Example 226, the subject matter of Example 225 optionally includes, wherein the object is a baseball, and wherein the scene includes a baseball pitch, and wherein tracking the user's movement includes tracking the user's attempt to hit the baseball during the baseball pitch, and wherein providing feedback includes providing timing information regarding the user's attempt to hit the baseball.

In Example 227, the subject matter of Example 226 optionally includes, wherein the timing information includes a visual or audio cue indicating a time to begin the attempt to hit the baseball.

In Example 228, the subject matter of any one or more of Examples 226-227 optionally include, wherein the timing information includes information of the user's performance compared to a model performance.

Example 229 is a system for defining a skill progression, the system comprising: an identification module to identify a plurality of skills of a physical activity; an skill organization module to organize the plurality of skills from more simple skills to more complex skills; a skill drill organization module to: organize a plurality of skill drills from drills that involve larger body parts to drills that involve smaller body parts; and for each of the plurality of skills, identify relevant skill drills from the plurality of skill drills; a skill drill progression module to organize the relevant skill drills into a skill progression sequence, the skill progression sequence including a subset of the plurality of skill drills for a skill from the plurality of skills; and a presentation module to present the skill progression sequence.

In Example 230, the subject matter of Example 229 optionally includes, wherein the physical activity includes hockey.

In Example 231, the subject matter of any one or more of Examples 229-230 optionally include, wherein the physical activity includes hockey, and the plurality of skills includes ice skating, shooting, stickhandling, and checking.

In Example 232, the subject matter of any one or more of Examples 229-231 optionally include, wherein the physical activity includes hockey, wherein the skill includes ice skating, and wherein the plurality of skill drills comprises posture exercises, leg motion exercises, and arm motion exercises.

In Example 233, the subject matter of any one or more of Examples 229-232 optionally include, wherein the physical activity includes hockey, wherein the skill includes shooting, and wherein the plurality of skill drills comprises weight transfer exercises, stick position exercises, and hand position exercises.

In Example 234, the subject matter of any one or more of Examples 229-233 optionally include, wherein the physical activity includes hockey, wherein the skill includes stickhandling, and wherein the plurality of skill drills comprises wrist roll exercises, peripheral vision exercises, and lower hand exercises.

In Example 235, the subject matter of any one or more of Examples 229-234 optionally include, wherein the skill drills are based on observational learning, visualization, posing, rapid posing, slow motion mimicking, or full speed mimicking.

In Example 236, the subject matter of any one or more of Examples 229-235 optionally include, wherein the presentation module is to: determine a gamification theme; and present the skill progression sequence using the gamification theme.

Example 237 is a method of defining a skill progression, the method comprising: identifying a plurality of skills of a physical activity; organizing the plurality of skills from more simple skills to more complex skills; organizing a plurality of skill drills from drills that involve larger body parts to drills that involve smaller body parts; for each of the plurality of skills, identifying relevant skill drills from the plurality of skill drills; organizing the relevant skill drills into a skill progression sequence, the skill progression sequence including a subset of the plurality of skill drills for a skill from the plurality of skills; and presenting the skill progression sequence.

In Example 238, the subject matter of Example 237 optionally includes, wherein the physical activity includes hockey.

In Example 239, the subject matter of any one or more of Examples 237-238 optionally include, wherein the physical activity includes hockey, and the plurality of skills includes ice skating, shooting, stickhandling, and checking.

In Example 240, the subject matter of any one or more of Examples 237-239 optionally include, wherein the physical activity includes hockey, wherein the skill includes ice skating, and wherein the plurality of skill drills comprises posture exercises, leg motion exercises, and arm motion exercises.

In Example 241, the subject matter of any one or more of Examples 237-240 optionally include, wherein the physical activity includes hockey, wherein the skill includes shooting, and wherein the plurality of skill drills comprises weight transfer exercises, stick position exercises, and hand position exercises.

In Example 242, the subject matter of any one or more of Examples 237-241 optionally include, wherein the physical activity includes hockey, wherein the skill includes stickhandling, and wherein the plurality of skill drills comprises wrist roll exercises, peripheral vision exercises, and lower hand exercises.

In Example 243, the subject matter of any one or more of Examples 237-242 optionally include, wherein the skill drills are based on observational learning, visualization, posing, rapid posing, slow motion mimicking, or full speed mimicking.

In Example 244, the subject matter of any one or more of Examples 237-243 optionally include, further comprising: determining a gamification theme; and presenting the skill progression sequence using the gamification theme.

Example 245 is a computer-readable medium including instructions for defining a skill progression, which when executed be a computer, cause the computer to perform the method of: identifying a plurality of skills of a physical activity; organizing the plurality of skills from more simple skills to more complex skills; organizing a plurality of skill drills from drills that involve larger body parts to drills that involve smaller body parts; for each of the plurality of skills, identifying relevant skill drills from the plurality of skill drills; organizing the relevant skill drills into a skill progression sequence, the skill progression sequence including a subset of the plurality of skill drills for a skill from the plurality of skills; and presenting the skill progression sequence.

In Example 246, the subject matter of Example 245 optionally includes, wherein the physical activity includes hockey.

In Example 247, the subject matter of any one or more of Examples 245-246 optionally include, wherein the physical activity includes hockey, and the plurality of skills includes ice skating, shooting, stickhandling, and checking.

In Example 248, the subject matter of any one or more of Examples 245-247 optionally include, wherein the physical activity includes hockey, wherein the skill includes ice skating, and wherein the plurality of skill drills comprises posture exercises, leg motion exercises, and arm motion exercises.

In Example 249, the subject matter of any one or more of Examples 245-248 optionally include, wherein the physical activity includes hockey, wherein the skill includes shooting, and wherein the plurality of skill drills comprises weight transfer exercises, stick position exercises, and hand position exercises.

In Example 250, the subject matter of any one or more of Examples 245-249 optionally include, wherein the physical activity includes hockey, wherein the skill includes stickhandling, and wherein the plurality of skill drills comprises wrist roll exercises, peripheral vision exercises, and lower hand exercises.

In Example 251, the subject matter of any one or more of Examples 245-250 optionally include, wherein the skill drills are based on observational learning, visualization, posing, rapid posing, slow motion mimicking, or full speed mimicking.

In Example 252, the subject matter of any one or more of Examples 245-251 optionally include, further comprising: determining a gamification theme; and presenting the skill progression sequence using the gamification theme.

Example 253 is a system for subskill classification, the system comprising: an access module to access a database of fundamental movements, each fundamental movement being uniquely identified with a corresponding identifier; a motion capture module to: analyze a motion capture video of an execution of a skill being performed; and deconstruct the motion capture video to identify a subset of fundamental movements that are used during the execution of the skill, the subset of fundamental movements from the database of fundamental movements; and a skill module to calculate a skill code, the skill code representing the skill and based on identifiers corresponding to the subset of fundamental movements.

In Example 254, the subject matter of Example 253 optionally includes, wherein the fundamental movements are selected from movements comprising: a joint flexion, a joint extension, or a joint rotation.

In Example 255, the subject matter of any one or more of Examples 253-254 optionally include, further comprising: a presentation module to present the skill code to a user.

In Example 256, the subject matter of Example 255 optionally includes, wherein to present the skill code the presentation module is to present the skill code with a plurality of other skill codes in an interrelated web of skill codes.

Example 257 is a method of subskill classification, the method comprising: accessing a database of fundamental movements, each fundamental movement being uniquely identified with a corresponding identifier; analyzing a motion capture video of an execution of a skill being performed; deconstructing the motion capture video to identify a subset of fundamental movements that are used during the execution of the skill, the subset of fundamental movements from the database of fundamental movements; and calculating a skill code, the skill code representing the skill and based on identifiers corresponding to the subset of fundamental movements.

In Example 258, the subject matter of Example 257 optionally includes, wherein the fundamental movements are selected from movements comprising: a joint flexion, a joint extension, or a joint rotation.

In Example 259, the subject matter of any one or more of Examples 257-258 optionally include, further comprising: presenting the skill code to a user.

In Example 260, the subject matter of Example 259 optionally includes, wherein presenting the skill code comprises: presenting the skill code with a plurality of other skill codes in an interrelated web of skill codes.

Example 261 is a computer-readable medium including instructions for subskill classification, which when executed be a computer, cause the computer to perform the method of: accessing a database of fundamental movements, each fundamental movement being uniquely identified with a corresponding identifier; analyzing a motion capture video of an execution of a skill being performed; deconstructing the motion capture video to identify a subset of fundamental movements that are used during the execution of the skill, the subset of fundamental movements from the database of fundamental movements; and calculating a skill code, the skill code representing the skill and based on identifiers corresponding to the subset of fundamental movements.

In Example 262, the subject matter of Example 261 optionally includes, wherein the fundamental movements are selected from movements comprising: a joint flexion, a joint extension, or a joint rotation.

In Example 263, the subject matter of any one or more of Examples 261-262 optionally include, further comprising: presenting the skill code to a user.

In Example 264, the subject matter of Example 263 optionally includes, wherein presenting the skill code comprises: presenting the skill code with a plurality of other skill codes in an interrelated web of skill codes.

1. (canceled)

2. A system for error detection and prioritization, the system comprising:
a processor;
memory including instructions, which when executed by the processor, cause the processor to:
determine a set of error detection parameters based on an identification of a physical skill executed by a person during an instance;
access an error detection database to obtain the set of error detection parameters, each error detection parameter describing a position of the person during execution of the physical skill, the execution having an execution timeframe; and
compare the instance of the person during execution of the physical skill against a model form to measure positional errors of the instance of the person during execution of the physical skill with respect to the model form; and
output, on a user interface, an indication of a positional error score based on the comparison.

3. The system of claim 2, wherein each of the error detection parameters are respectively associated with a time range in the execution timeframe of the physical skill.

4. The system of claim 3, wherein measuring positional errors of the instance of the person with respect to the model form for a particular error detection parameter is performed in the time range associated with the particular error detection parameter.

5. The system of claim 2, wherein the error detection parameters are based on a joint angle corresponding to joint positions or a linear displacement corresponding to limb positions or body positions during the execution of the physical skill.

6. The system of claim 2, wherein the instructions further cause the processor to:
identify a largest positional error of the measure positional errors;
obtain a specific exercise to address the largest positional error from a skills database based on the largest positional error; and
present the a specific exercise to address the largest positional error to the user.

7. The system of claim 2, wherein the instructions further cause the processor to determine that positional errors of the instance of the person with the model form are each less than a corresponding threshold, and notify a user that the instance of the person during execution of the physical skill as a successful performance.

8. The system of claim 2, wherein the set of error detection parameters are determined based on common errors stored in the error detection database of previous attempts by other persons of the physical skill or instructor-identified errors.

9. The system of claim 2, wherein to compare the instance of the person during execution of the physical skill against the model form, the instructions further cause the processor to use weights associated with the set of error detection parameters.

10. The system of claim 2, wherein the indication of the positional error score includes at least one of an overall score, a score for a particular portion of the physical skill, a score relative to a previous attempt to perform the physical skill, or a score relative to a score of the model form.

11. The system of claim 2, wherein the comparison is based on a best fit analysis of body segments of the person during execution of the physical skill to the model form at a particular time within the execution timeframe.

12. A method for error detection and prioritization, the method comprising:
determining, using a processor, a set of error detection parameters based on an identification of a physical skill executed by a person during an instance;
accessing an error detection database to obtain the set of error detection parameters, each error detection parameter describing a position of the person during execution of the physical skill, the execution having an execution timeframe; and
comparing, using the processor, the instance of the person during execution of the physical skill against a model form to measure positional errors of the instance of the person during execution of the physical skill with respect to the model form; and
outputting, on a user interface, an indication of a positional error score based on the comparison.

13. The method of claim 12, wherein each of the error detection parameters are respectively associated with a time range in the execution timeframe of the physical skill.

14. The method of claim 13, wherein measuring positional errors of the instance of the person with respect to the model form for a particular error detection parameter includes measuring the positional errors in the time range associated with the particular error detection parameter.

15. The method of claim 12, wherein the error detection parameters are based on a joint angle corresponding to joint positions or a linear displacement corresponding to limb positions or body positions during the execution of the physical skill.

16. The method of claim 12, further comprising:
identifying a largest positional error of the measure positional errors;
obtaining a specific exercise to address the largest positional error from a skills database based on the largest positional error; and
presenting the a specific exercise to address the largest positional error to the user.

17. The method of claim 12, further comprising determining that positional errors of the instance of the person with the model form are each less than a corresponding threshold, and notifying a user that the instance of the person during execution of the physical skill as a successful performance.

18. The method of claim 12, wherein the set of error detection parameters are determined based on common errors stored in the error detection database of previous attempts by other persons of the physical skill or instructor-identified errors.

19. The method of claim 12, wherein comparing the instance of the person during execution of the physical skill against the model form includes using weights associated with the set of error detection parameters.

20. The method of claim 12, wherein the indication of the positional error score includes at least one of an overall score, a score for a particular portion of the physical skill, a score relative to a previous attempt to perform the physical skill, or a score relative to a score of the model form.

21. The method of claim 12, wherein the comparison is based on a best fit analysis of body segments of the person during execution of the physical skill to the model form at a particular time within the execution timeframe.
